(19) United States
(12) Patent Application Publication
(10) Pub. No.: US 2004/0039608 A1
(43) Pub. Date: Feb. 26, 2004

(54) Health benefit system and methodology

(75) Inventors: Christopher Mazur, Beverly Hills, MI (US); Rong Zhang, Madison Heights, MI (US); Susan Weinrauch, White Lake, MI (US); Susan LaFreniere, Macomb Township, MI (US); John Simmons, Grosse Pointe Woods, MI (US)

Correspondence Address: Tanya L. Garrett, Dobrusin & Thennisch PC, Suite 311, 401 South Old Woodward Avenue, Birmingham, MI, 48009, US

(73) Assignee: Lulac, LLC

(21) Appl. No.: 10/177,204

(22) Filed: Jun. 21, 2002

(51) Int. Cl. G06F 17/60

(52) U.S. Cl. 705/4

(57) ABSTRACT

The present invention provides a computer-implemented system and method for providing a post employment qualified health care benefit plan funded during a covered person's working years to covered persons under the plan. The method having the steps of providing a computer system to manipulate and process a plurality of predefined variables; electing a number of benefit payout years for receiving benefits during a payout period; electing either a standard non-lump-sum premium option or a lump sum premium option; electing standard non-lump-sum variables under the standard non-lump-sum premium option; electing lump sum variables under the lump sum premium option; using the computer system to calculate a schedule of premiums based on the standard non-lump-sum variables and the lump sum variables to obtain an associated maximum benefit amount; and paying a maximum benefit amount for qualified health expenses upon occurrence of a triggering event.

### FIELD OF THE INVENTION

The present invention relates generally to post-retirement insurance plans, methods, and systems. More particularly, the present invention discloses and recites a self-funded health benefits or insurance plan, which provides post-employment on retirement health benefits.

### BACKGROUND OF THE INVENTION

Existing post-employment or retirement health care insurance are generally provided through a Medicare or a prior employer health insurance program. In either case, there remain some uninsured health expenses. Additionally, existing health insurance plans that provide post-employment or retirement health benefits are generally coordinated post-retirement pension plans that are set up as trust accounts, which are subject to regulatory requirements under the Internal Revenue Service (hereinafter, “IRS”) code. Additionally, existing individual or group insurance plans that a retired person can buy during retirement are not available for purchase with pre-tax money; thus, the existing plans can be prohibitively expensive. Typically, such benefit plans do not allow flexibility of receiving benefits for a specified period of time post-retirement, thus reducing premium payments paid while working. A flexible post-employment or retirement plan is typically not provided by existing health plans.

The use of a self-funded health benefits or insurance plan provides a major advantage over the existing insurance-based plans.

There remains a need for an accident and health insurance product for post employment or retirement health expenses paid for during working years.

There remains a more particular need for such a system that is more cost effective than the existing insurance-based plans, and which provides a level of customization and flexibility in the design of the specific employer's plan that is unknown in existing plans.

There remains an additional need for such a computer system that is capable of periodically remodeling the entire benefits plan and recalculating specific contribution levels in order to ensure that the plan is properly funded on an ongoing basis.

An object of the present invention is to provide a system and method for collecting employee premium contributions to a medical health benefits plan and to invest these contributions so as to provide a future benefit to reimburse post-employment or retirement qualified health care expenses.

The present invention provides a post-employment or retirement health insurance system and plan that is paid for during working years, which includes a computer system, specific data processing software—for processing data via computer system to allow an employee to elect either a standard non-lump-sum premium pay-in option or a lump sum premium pay-in option to receive a benefit over a predefined number of payout years—and a method for distributing benefits to reimburse a qualified person under the plan.

### SUMMARY OF THE INVENTION

The present invention is directed toward the field of computer-implemented employee benefit plans. In particular, a system and method for designing and administering a post-employment or retirement health insurance benefit plan is disclosed. This system and method are implemented in a general computer system using operating software (“senior lifestyles benefit plan software”) that carries out the functions disclosed in this application to turn the general computer system to a specific computer system when the senior lifestyles benefit plan software is used. Along with the specific-purpose computer system operating the senior lifestyles benefit plan software, the system includes a benefit distribution provision for distributing benefits or return of premiums upon occurrence of a triggering event. The novel computer system and software are used to design and implement an employee-specific or individual-specific post employment or post retirement benefit plan, and then to allow an insurance company to manage the ongoing administration of the plan, thereby removing such an administrative burden from an employer, an employee, or an individual.

More particularly, the method allows a person, who is covered under the plan to pay a flat premium, preferably pre-tax, while working, and to get a medical expense reimbursement or a benefit up to a selected maximum annual benefit amount for certain number of years after retirement or after leaving an employer offering the insurance product. It is assumed that each annual maximum benefit amount is paid out at mid-year. The annual benefit is paid for covered medical expenses incurred during a calendar year, preferably beginning January 1^{st} and ending December 31^{st}, however any other time-period may be specified under the policy. A covered person is any person legally qualified to receive benefits under the plan as defined by the plan in accordance with the IRS code.

The senior lifestyles benefit plan software program preferably includes a spreadsheet workbook having an assumptions sheet; a layout sheet; and a lump sum payment layout sheet wherein each sheet is in communication with a plurality of databases, the databases having a mortality table, a premiums paid table, and a credited or future interest rate. Together, these sheets cooperate to enable the functionality of the present invention. However the objectives of the present invention may be met by using an alternative software program that performs calculations using predefined variables to calculate a credited interest rate, associated benefits and associated premiums.

The detailed functionality of each sheet is described more fully below. In general terms, however, the assumptions sheet is used to collect certain employee data and to store that certain information into at least the layout sheet or the lump sum layout sheet. The assumptions sheet is used to store all of the employee specific information that is used by the other spreadsheets to design, implement and manage the senior lifestyles benefit plan. The layout sheet and the lump sum layout sheet are used to design, model, calculate and generate specific employee premium payment reports according to a method using the present invention.

The system also includes a means for recalculating the entire lifestyles benefit plan in case of an occurrence a triggering event.

Additionally, a computer-implemented data-processing method is disclosed for providing post-retirement qualified health care benefits plan funded during a covered person's working years to a person or persons covered under the plan, comprising the steps of:

1. providing a computer system for executing the computer-implemented method, the computer system having a data processing program to manipulate and process a plurality of variables input into the program;

2. electing a number of benefit payout years for receiving benefits during a payout period, wherein the benefit payout years are selected from the group of l under a standard non-lump-sum premium option, or r under a lump sum premium option;

3. electing a premium pay-in option wherein the pay-in option consists of the group selected from a standard non-lump-sum option and a lump sum option;

4. selecting and inputting into the data processing program standard non-lump-sum variables if the standard non-lump-sum premium option is elected by the employee, the standard non-lump-sum variables having a number of pay-in years k for an associated number of payout years l, and an annual maximum benefit amount B;

5. selecting and inputting into the data processing program lump sum variables if the lump sum premium option is elected by the employee, the lump sum variables having a number of elimination years q for an associated number of lump sum payout years r, and a lump sum annual maximum benefit amount LB;

6. using the data processing program to calculate a schedule of premiums to be paid based on at least one of the standard non-lump-sum variables and the lump sum variables to obtain an associated maximum benefit amount; and

7. paying a maximum benefit amount for qualified health expenses incurred by eligible plan members upon occurrence of a triggering event.

Preferably, the triggering event is selected from the group consisting of a lapse in paying premiums, an employee's retirement, an employee's total disability, an employee's termination of employment, and an employee's death, wherein termination of employment is when an employee covered under the insurance plan is terminated from employment or terminates employment from an employer offering the insurance product. However, the employee may be employed by a different employer after termination of employment and may be still eligible to receive benefits under the plan.

Preferably, additional steps are provided as an added feature of the present invention. The additional steps may preferably include:

returning up to 100% of the paid premiums to a covered person or entity if the triggering event of an employee's death occurs during the pay-in period;

paying benefits up to a selected annual maximum for a predefined payout period if the triggering event occurs during the payout period;

carrying over a balance of an unused amount of annual maximum benefits to proportionately extend the balance of the unused amount to the length of the payout period;

providing an optional accelerated payout benefit option allowing an employee planholder to reduce the elected payout period by discounting future benefits to a present value using a 10% discount rate when a covered person is eligible to receive benefits during the payout period for any reason;

providing lapse payment benefits when a triggering event of a lapse occurs during the pay-in years under a standard option or during the elimination period under the lump sum option, wherein the lapse payment is the actual premium paid in divided by the expected premium multiplied by a surcharge rate, preferably 80%, multiplied by the number of $1,000 benefit units.

These are just some of the many advantages provided by the present invention, described illustratively in more detail below. As will be appreciated, the invention is capable of other and different embodiments, and its several details are capable of modification in various respects, all without departing from the spirit of the invention. Accordingly, the drawings and description of the preferred embodiment are to be regarded as illustrative in nature and not restrictive.

### BRIEF DESCRIPTION OF THE DRAWINGS

The present invention satisfies the needs remaining in this art and provides the advantages noted above, as well as many other advantages, as will become apparent from the following description when read in conjunction with the accompanying drawings wherein:

FIG. 1 is a block diagram of a computer system provided for use in implementing a lifestyles senior plan in accordance with the present invention;

FIG. 2 is a flowchart detailing steps necessary to implement the present invention;

FIG. 3 is a flowchart detailing steps necessary to calculate a standard non-lump-sum option premium schedule in accordance with one embodiment of the present invention;

FIG. 4 is a flowchart detailing steps necessary to calculate a standard credited interest rate for an associated pay-in year and payout year under a standard option in accordance with the present invention;

FIG. 5 is a graphical illustration of an assumptions spreadsheet, the assumptions spreadsheet having a standard non-lump-sum assumptions portion and a lump sum assumptions portion in accordance with the present invention;

FIG. 6 is a graphical illustration of a layout spreadsheet for use in accordance with a standard non-lump-sum option of the present invention;

FIG. 7 is a flowchart detailing steps necessary to calculate a lump sum option premium schedule in accordance with one embodiment of the present invention;

FIG. 8 is a flowchart detailing steps necessary to calculate a lump sum credited interest rate for an associated elimination year and payout year under a lump sum option in accordance with one embodiment of the present invention;

FIG. 9 is a graphical illustration of a lump sum layout spreadsheet for use in accordance with a lump sum option of the present invention;

FIG. 10 is a flowchart detailing benefit options provided upon occurrence of a triggering event in accordance with one embodiment of the present invention.

### DETAILED DESCRIPTION OF THE PREFERRED EMBODIMENTS

The present invention discloses a system and method for using a post-employment or retirement insurance plan (herein after “lifestyles senior benefit plan”) to allow an employee to fund the plan during working years to receive a future benefit in the form of a post-employment or retirement health care reimbursement for qualified medical expenses. The system further provides future benefit amounts in multiples of a unit amount that are funded by premiums paid by the covered person or another entity, preferably, an employer. Preferably, the contributions to the plan are directly deducted in a pre-tax manner from the employee's paycheck while working for an employer offering the plan through an insurance company.

Preferably, a covered person or planholder is an employee of an employer providing the senior lifestyles benefit plan, who 1) meets the eligibility requirements for coverage, namely, a person involved in the regular business of and paid for services by the employer and is a full-time employee or a partner or proprietor engaged in the business of the employer on a full-time basis; 2) is enrolled under the plan; and 3) makes timely payments of the required premium. An employee can preferably enroll during an open enrollment period if the employee had not originally applied for coverage. Preferably, a covered person's spouse and dependants are also eligible to receive benefits under the senior lifestyles plan.

An employer is preferably, an individual proprietorship, partnership, or corporation that meets the insurance company's definition of employer.

The plan is a benefits plan and is preferably, nonassignable. The payments or benefits are paid directly to the covered person and the benefits received will not be reduced by amounts paid under any other type of insurance program.

Benefits paid to a covered person under the plan are made to the person for covered medical expenses, wherein the covered medical expenses are qualified health care expenses under the Internal Revenue Service code.

Preferably, expenses not covered include any expenses not recognized under the qualified health care expenses under the Internal Revenue Service code.

Referring now to the drawings, as shown in FIG. 1, the present invention is implemented with the aid of a digital computer system to perform digital data processing in accordance with the method of the present invention. One example of such a system is represented in FIG. 1. The illustrated digital computer system 10 includes a central processing unit (cpu) 12 having data, address and control buses and connections (not shown) to which at least one memory device 14, at least one data entry device 16, and at least one output device 18 are connected for control by the cpu 12.

The present invention may be implemented in whole, or in part, on a computer with a Pentium processor, hard drive, 16 MB of RAM and running an operation system comparable to Windows '95. At least one data entry device 16 is provided for receiving selected variables. Additionally, at least one data entry device 16 may include a keyboard (as shown in FIG. 1), a magnetic tape, and a floppy disk or other conventional input means well known in the data processing arts.

Preferably the output device 18 is also attached thereto for communicating results of the present invention from the computer to another location. It should be noted that any combination of computer hardware (processor, monitor, memory, server, network, etc.) could be used to create the structure of the present system, as shown. It should also be noted that any of the software functions, steps or elements described herein can be implemented in any conventionally known computer.

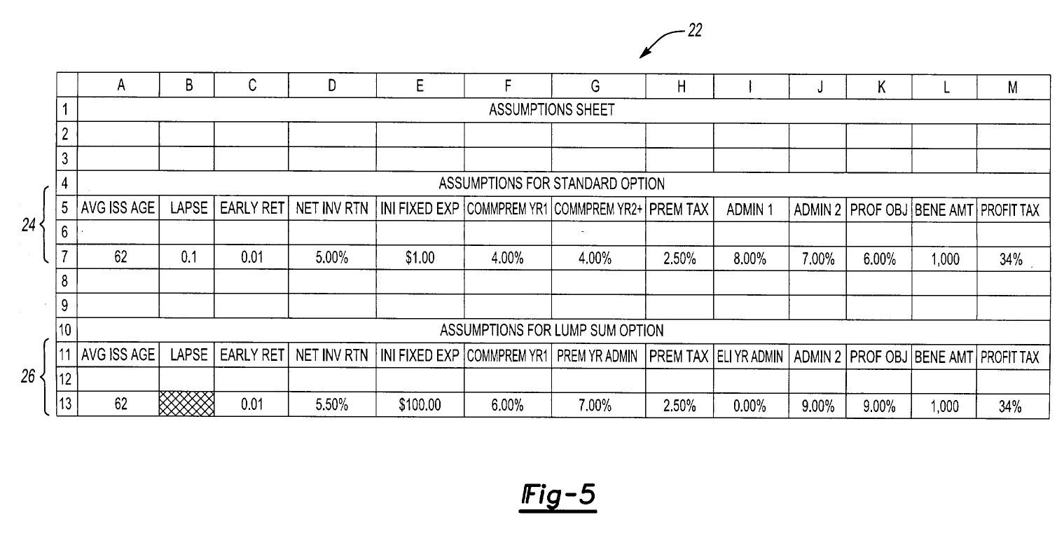

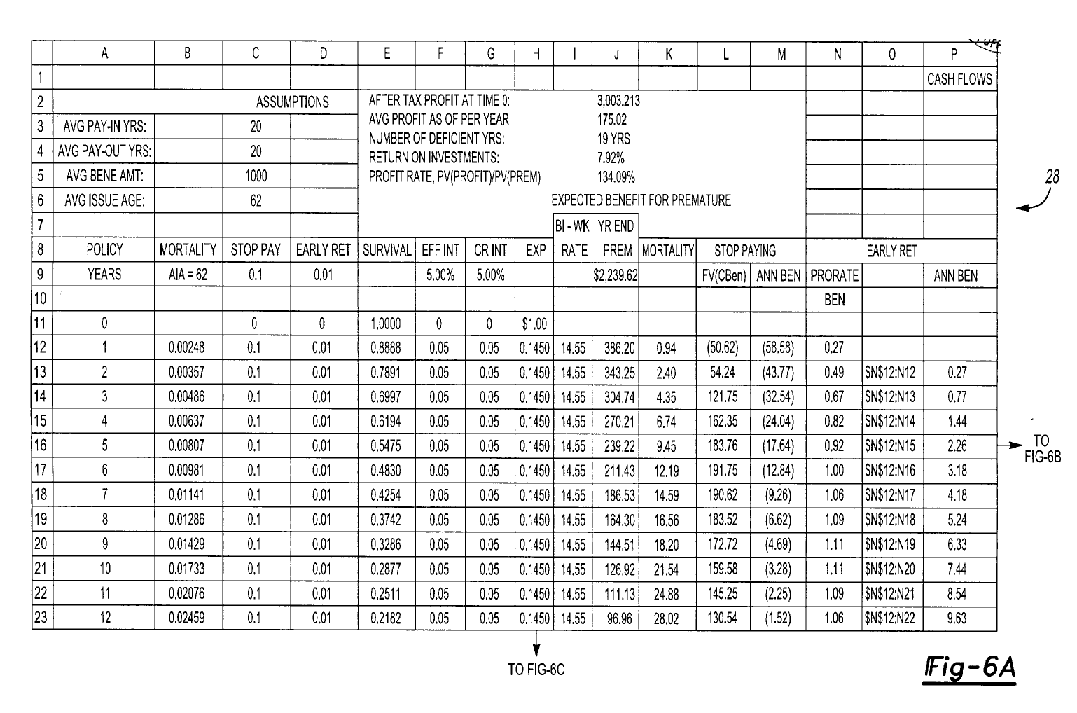

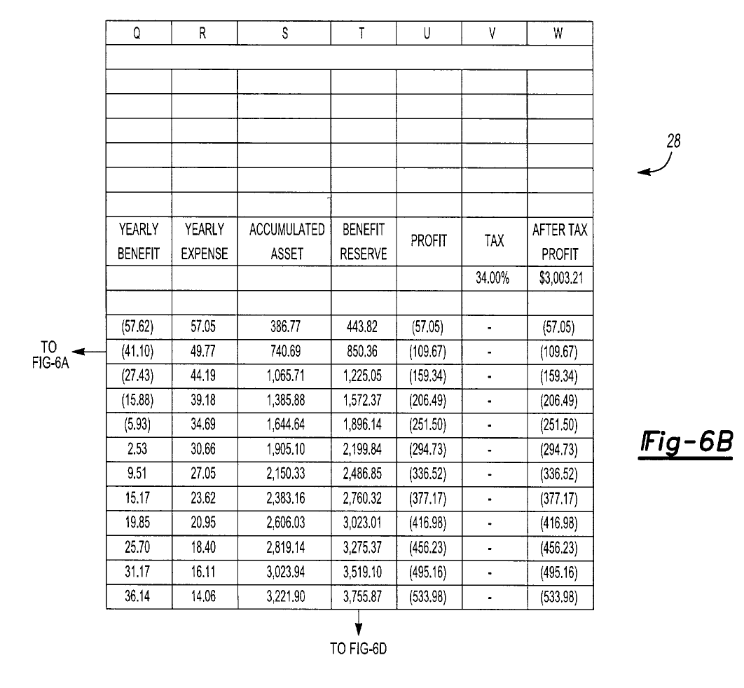

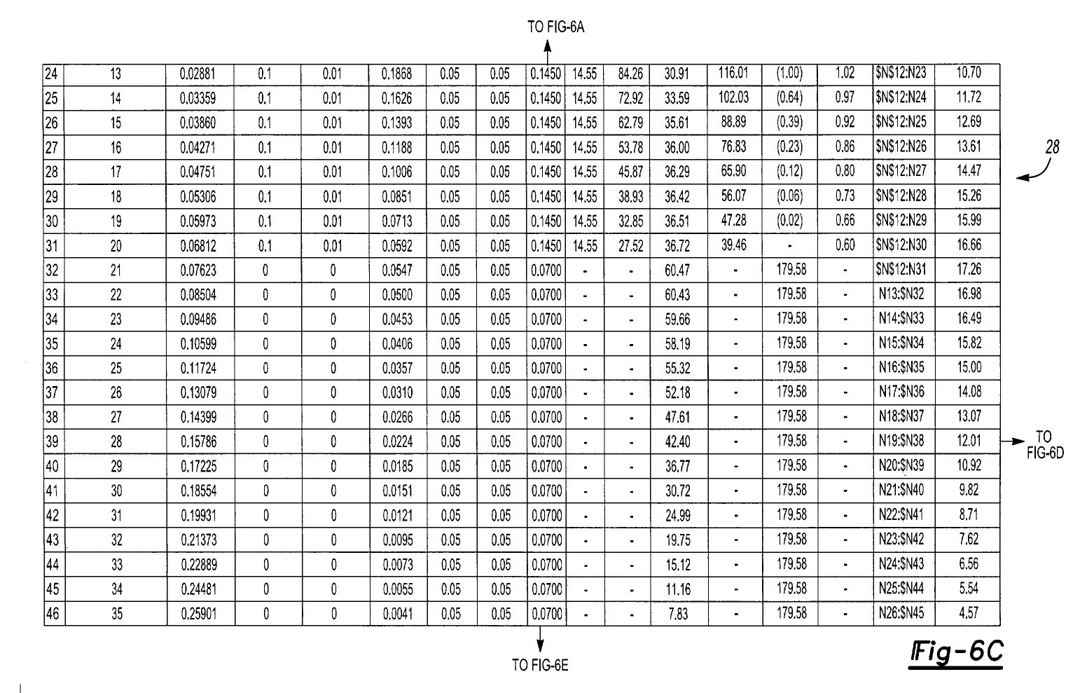

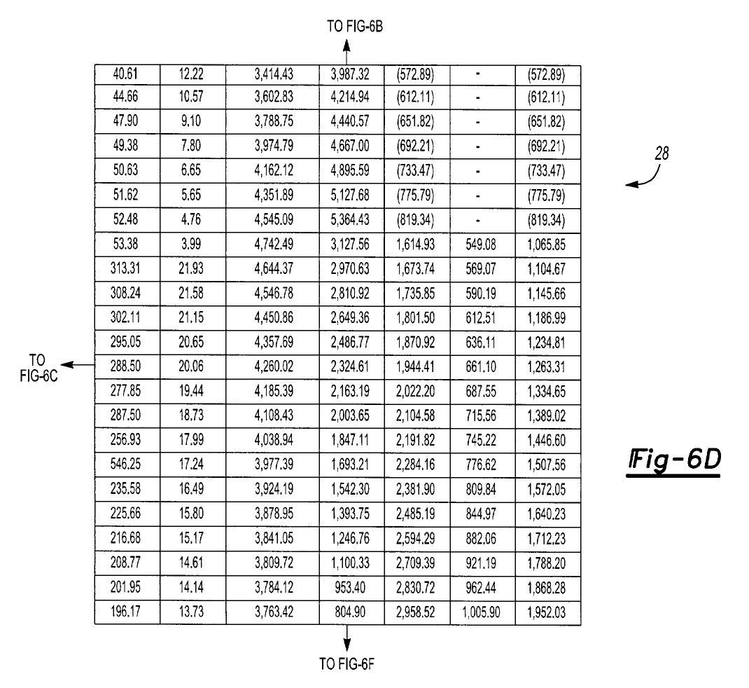

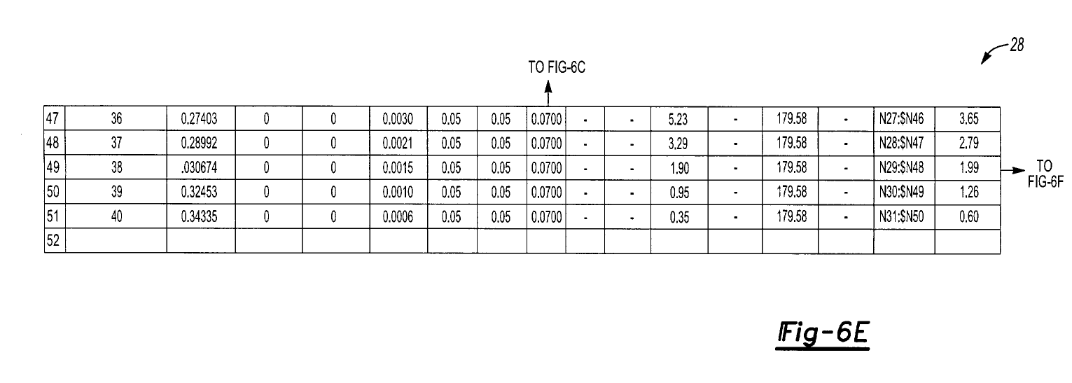

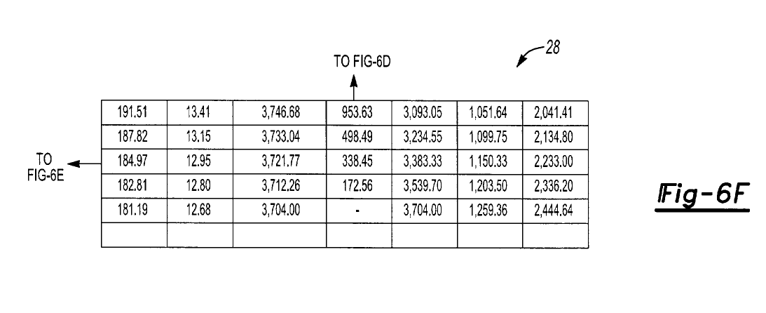

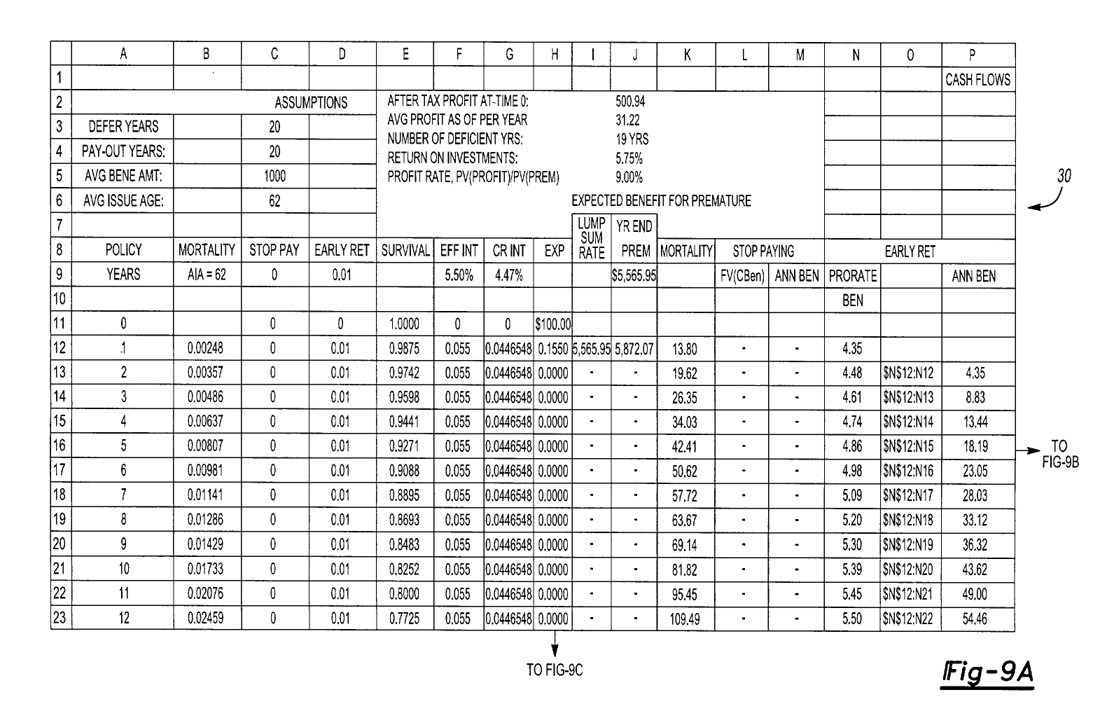

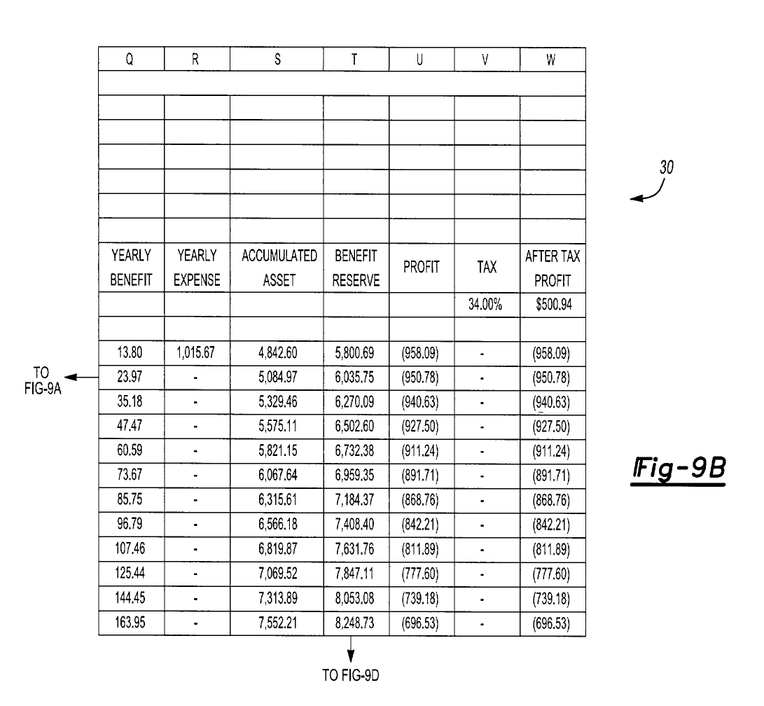

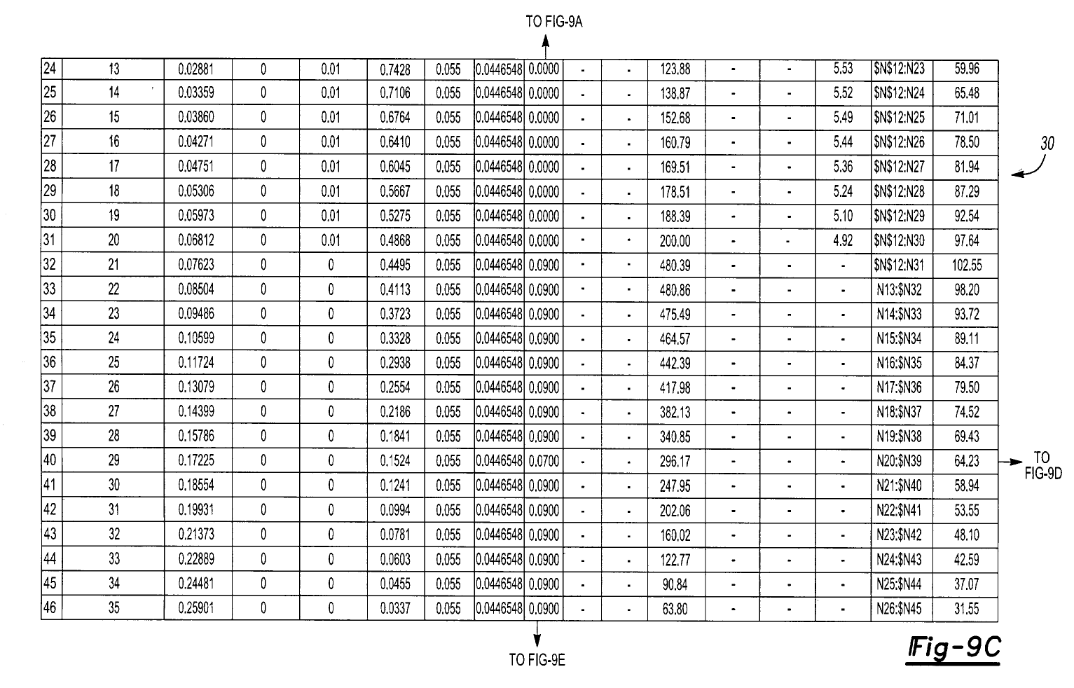

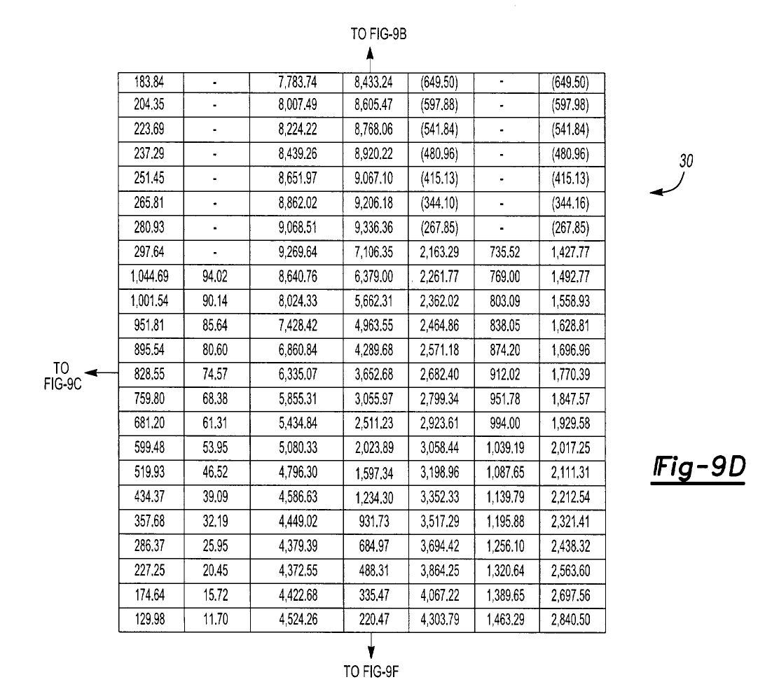

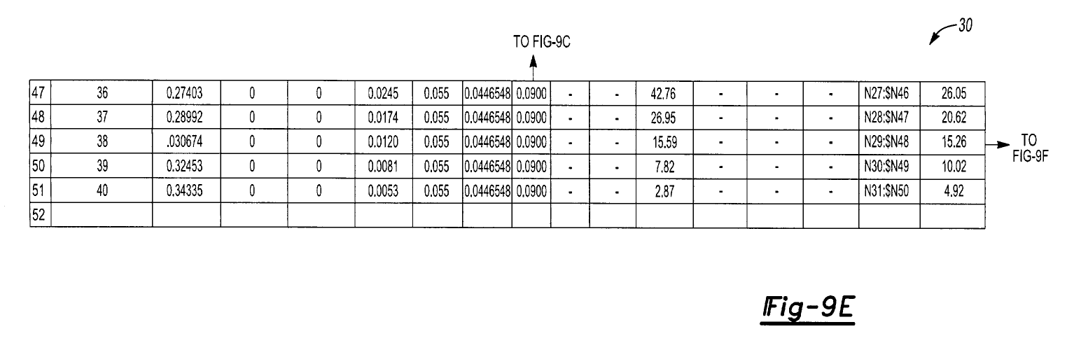

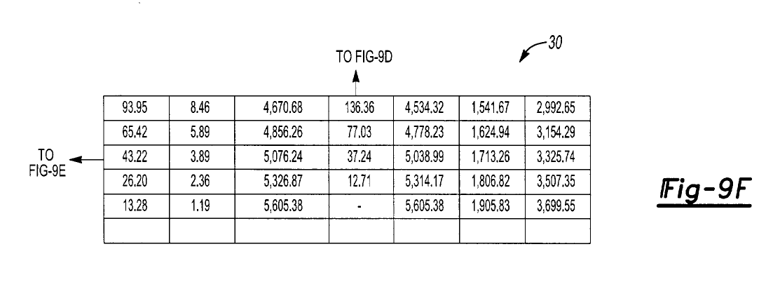

The CPU 12 includes a main operating program under which the CPU operates. The main operating program includes conventional programming for the particular CPU used, and it also includes a specific data processing application program implementing the method of the present invention as further described below. Preferably, the specific application program used is a data processing software program such as Microsoft® Excel or Microsoft® Access that provides at least one workbook having a plurality of linked spreadsheets capable of processing a plurality of input variables to output an associated premium amount necessary to pay for a future benefit. The plurality of spreadsheets preferably include an assumptions sheet 22 as shown in FIG. 5 having a standard non-lump-sum assumptions portion 24 and a lump sum assumptions portion 26, a layout sheet 28 as shown in FIG. 6, a lump sum layout sheet 30 as shown in FIG. 9, wherein each sheet has a plurality of columns and rows having a plurality of cells disposed therewithin, wherein each cell is first identified by an associated column and then an associated row. However, any suitable programmable data management program or spreadsheet program may be used in accordance with the present invention.

Assumption variables are input into the plurality of associated cells within the assumptions spreadsheet 22, wherein the assumptions include, but are not limited to mortality rates; average issue age, lapse rates; early retirement rates; net investment returns; initial fixed expenses; commission expenses; administration expenses; premium taxes, profits; contemplated years of coverage; pay-in-years; pay-out-years; and a contemplated amount of future annual benefits. The variables in the assumptions spreadsheet can be defined and changed by a user to allow for different scenarios and run the calculation, however, all other fields within the workbook should not change.

The layout sheet 28 and the lump sum layout sheet 30 each cooperate with the standard non-lump-sum assumptions portion 24 of the assumptions sheet and the lump sum assumptions portion 26 respectively to generate a credited interest rate table, the credited interest rate table having a standard credited interest rate portion and a lump credited interest rate portion as shown in Table 1 below, and a premium schedule table as shown in Table 2, the premium schedule table having a standard bi-weekly premium portion, and a lump sum premium portion.

CREDITED INTEREST RATE TABLE 1
Standard Credited Interest Rate Portion
Number of years benefit will be paid out

| | | | | | | | | | |
|---|---|---|---|---|---|---|---|---|---|
| 1 | 2 | 3 | 4 | 5 | 6 | 7 | 8 | 9 | 10 |

Pd-in yrs

| | | | | | | | | | | |
|---|---|---|---|---|---|---|---|---|---|---|
| 1 | −60,000% | −27.842% | −16.398% | −11.028% | −7.888% | −5.767% | −4.242% | −3.123% | −2.243% | −1.329% |
| 2 | −20.742% | −13.564% | −9.303% | −6.566% | −4.720% | −2.406% | −2.393% | −1.602% | −0.975% | −0.455% |
| 3 | −11.050% | −7.580% | −6.345% | −3.752% | −2.583% | −1.855% | −0.957% | −0.380% | 0.083% | 0.471% |
| 4 | −8.576% | −4.400% | −2.922% | −1.824% | −1.005% | −0.359% | 0.164% | 0.598% | 0.950% | 1.251% |
| 5 | −3.891% | −2.356% | −1.310% | −0.508% | 0.121% | 0.626% | 1.038% | 1.377% | 1.659% | 1.901% |
| 6 | −2.129% | −0.960% | −0.150% | 0.477% | 0.976% | 1.582% | 1.716% | 1.995% | 2.231% | 2.432% |
| 7 | −0.904% | 0.03 [symbol] % | 0.709% | 1.226% | 1.643% | 1.983% | 2.265% | 2.502% | 2.703% | 2.674% |
| 8 | −0.025% | 0.784% | 1.359% | 1.805% | 2.166% | 2.463% | 2.711% | 2.918% | 3.095% | 3.246% |
| 9 | 0.642% | 1.363% | 1.860% | 2.258% | 2.680% | 2.847% | 3.971% | 3.259% | 3.419% | 3.556% |
| 10 | 1.162% | 1.797% | 2.254% | 2.613% | 2.910% | 3.156% | 3.363% | 3.638% | 3.687% | 3.815% |
| 11 | 1.576% | 1.151% | 2.568% | 2.899% | 3.174% | 3.405% | 3.600% | 3.766% | 3.908% | 4.029% |
| 12 | 1.907% | 2.438% | 2.822% | 3.120% | 3.388% | 3.607% | 3.793% | 3.952% | 4.088% | 4.206% |
| 13 | 2.181% | 2.672% | 3.029% | 3.317% | 3.592% | 3.770% | 3.949% | 4.103% | 4.236% | 4.351% |
| 14 | 2.411% | 2.866% | 3.200% | 3.472% | 3.794% | 3.903% | 4.076% | 4.226% | 4.356% | 4.489% |
| 15 | 2. [symbol] 03% | 3.029% | 3.344% | 3.699% | 3.820% | 4.012% | 4.179% | 4.325% | 4.453% | 4.585% |
| 16 | 2.768% | 3.188% | 3.464% | 3.706% | 3.916% | 4.100% | 4.282% | 4.404% | 4.530% | 4.641% |
| 17 | 2.911% | 3.2 [symbol] 7% | 3.566% | 3.795% | 3.995% | 4.172% | 4.329% | 4.468% | 4.591% | 4.700% |
| 18 | 3.034% | 3.388% | 3.654% | 3.870% | 4.081% | 4.231% | 4.383% | 4.518% | 4.639% | 4.747% |
| 19 | 3.142% | 3.47 [symbol] % | 3.729% | 3.935% | 4.117% | 4.280% | 4.426% | 4.558% | 4.676% | 4.782% |
| 20 | 3.238% | 3.557% | 3.795% | 3.9 [symbol] 0% | 4.164% | 4.321% | 4.462% | 4.589% | 4.705% | 4.809% |

| | | | | | | | | | |
|---|---|---|---|---|---|---|---|---|---|
| 11 | 12 | 13 | 14 | 15 | 16 | 17 | 18 | 19 | 20 |

Pd-in yrs

| | | | | | | | | | | |
|---|---|---|---|---|---|---|---|---|---|---|
| 1 | −0.970% | −0.491% | −0.084% | 0.261% | [symbol] | 0.828% | 1.061% | 1.269% | 1.45 [symbol] % | 1.624% |
| 2 | −0.020% | 0.345% | 0.061% | 0.936% | 1.178% | 1.388% | 1.678% | 1.74 [symbol] % | 1.901% | 2.039% |
| 3 | 0.802% | 1.087% | 1.335% | 1.551% | 1.742% | 1.914% | 2.068% | 2.203% | 2.328% | 2.442% |
| 4 | 1.510% | 1.735% | 1.930% | 2.103% | 2.257% | 2.394% | 2.517% | 2.628% | 2.730% | 2.823% |
| 5 | 2.110% | 2.291% | 2.449% | 2.689% | 2.714% | 2.826% | 2.926% | 3.017% | 3.100% | 3.176% |
| 6 | 2.806% | 2.758% | 2.891% | 3.008% | 3.113% | 3.205% | 3.289% | 3.365% | 3.433% | 3.496% |
| 7 | 3.023% | 3.152% | 3.265% | 3.365% | 3.454% | 3.533% | 3.604% | 3.668% | 3.726% | 3.779% |
| 8 | 3.377% | 3.490% | 3.589% | 3.877% | 3.754% | 3.823% | 3.884% | 3.940% | 3.990% | 4.035% |
| 9 | 3.675% | 3.777% | 3.687% | 3.946% | 4.015% | 4.077% | 4.132% | 4.181% | 4.225% | 4.264% |
| 10 | 3.925% | 4.021% | 4.104% | 4.177% | 4. [symbol] 41% | 4.298% | 4.348% | 4.393% | 4.433% | 4.469% |
| 11 | 4.134% | 4.226% | 4.305% | 4.376% | 4.436% | 4.489% | 4.527% | 4.579% | 4.817% | 4.650% |
| 12 | 4.308% | 4.397% | 4.474% | 4.542% | 4. [symbol] 01% | 4.653% | 4.700% | 4.741% | 4.777% | 4.809% |
| 13 | 4.451% | 4.538% | 4.615% | 4.682% | 4.741% | 4.793% | 4.839% | 4.879% | 4.916% | 4.948% |
| 14 | 4.568% | 4.655% | 4.731% | 4.799% | 4.858% | 4.910% | 4.957% | 4.998% | 5.000% | 5.000% |
| 15 | 4.663% | 4.750% | 4.821% | 4.894% | 4.954% | 5.000% | 5.000% | 5.000% | 5.000% | 5.000% |
| 16 | 4.739% | 4.826% | 4.903% | 4.971% | 5.000% | 5.000% | 5.000% | 5.000% | 5.000% | 5.000% |
| 17 | 4.798% | 4.8 [symbol] 5% | 4.962% | 5.000% | 5.000% | 5.000% | 5.000% | 5.000% | 5.000% | 5.000% |
| 18 | 4.844% | 4.930% | 5.000% | 5.000% | 5.000% | 5.000% | 5.000% | 5.000% | 5.000% | 5.000% |
| 19 | 4.87 [symbol] % | 4.965% | 5.000% | 5.000% | 5.000% | 5.000% | 5.000% | 5.000% | 5.000% | 5.000% |
| 20 | 4.904% | 4.990% | 5.000% | 5.000% | 5.000% | 5.000% | 5.000% | 5.000% | 5.000% | 5.000% |

Lump Sum Credited Interest Rate Portion

| | | | | | | | | | |
|---|---|---|---|---|---|---|---|---|---|
| 1 | 2 | 3 | 4 | 5 | 6 | 7 | 8 | 9 | 10 |

[symbol]

Year

| | | | | | | | | | | |
|---|---|---|---|---|---|---|---|---|---|---|
| 1 | −29.290% | −17.706% | −11.922% | −8.44 % | −6.213% | −4.599% | −3.375% | −2.439% | −1.687% | −1.066% |
| 2 | −14.662% | −9.284% | −8.541% | −4.747% | −3.438% | −2.4 9% | −1.687% | −1.034% | −0.506% | −0.068% |
| 3 | −9.513% | −5.786% | −3.931% | −2.707% | −1. 74% | −1.121% | −0.556% | −0.085% | 0.306% | 0.644% |
| 4 | −8.629% | −3.791% | −2.376% | −1.436% | −0.749% | −0.212% | 0.228% | 0.592% | 0.905% | 1.178% |
| 5 | −4.81 [symbol] 0% | −2.443% | −1.295% | −0.551% | 0.004% | 0.446% | 0.806% | 1.107% | 2.368% | 1.594% |
| 6 | −3.519% | −1.489% | −0.518% | 0.1 [symbol] 7% | 0.585% | 0.951% | 1.254% | 1.513% | 1.735% | 1.928% |
| 7 | −2.588% | −0.769% | 0.088% | 0. [symbol] % | 1.036% | 1.357% | 1.620% | 1.842% | 2.0 [symbol] 57% | 2.206% |
| 8 | −1.855% | −0.205% | 0.556% | 1.046% | 1.407% | 1.688% | 1.921% | 2.119% | 2.290% | 2.440% |
| 9 | −1.280% | 0.242% | 0.943% | 1.386% | 1.709% | 1.965% | 2.176% | 2.353% | 2.507% | 2.643% |
| 10 | −0.814% | 0.614% | 1.259% | 1.668% | 1.967% | 2.201% | 2.39 [symbol] % | 2.550% | 2.097% | 2.821% |
| 11 | −0.42 [symbol] % | 0.917% | 1.527% | 1.910% | 2.186% | 2.404% | 2.584% | 2.734% | 2.865% | 2.980% |
| 12 | −0.109% | 1.177% | 1.755% | 2.116% | 2. [symbol] 79% | 2.583% | 2.750% | 2.893% | 3.016% | 3.123% |
| 13 | 0.163% | 1.397% | 1.951% | 2.298% | 2.546% | 2.741% | 2.901% | 3.035% | 3.152% | 3.254% |
| 14 | 0.394% | 1.587% | 2.123% | 2.455% | 2.696% | 2.883% | 3.036% | 3.165% | 3.276% | 3.374% |
| 15 | 0.592% | 1.752% | 2.272% | 2.597% | 2.829% | 3.010% | 3.158% | 3.283% | 3.392% | 3.488% |
| 16 | 0.784% | 1.895% | 2.404% | 2.720% | 2.948% | 3.124% | 3.269% | 3.391% | 3.496% | 3.589% |
| 17 | 0.812% | 2.021% | 2.518% | 2.831% | 3.054% | 2.228% | 3.370% | 3.490% | 3.593% | 3.684% |
| 18 | 1.042% | 2.120% | 2.822% | 2.929% | 3.149% | 3.321% | 3.462% | 3.580% | 3.682% | 3.772% |
| 19 | 1.155% | 2.226% | 2.713% | 3.017% | 3.235% | 3.406% | 3.545% | 3.6 [symbol] % | 3.765% | 3.854% |
| 20 | 1.253% | 2. [symbol] % | 2.794% | 3.098% | 3.314% | 3.484% | 3.623% | 3.741% | 3.84 [symbol] % | 3.932% |

| | | | | | | | | | |
|---|---|---|---|---|---|---|---|---|---|
| 11 | 12 | 13 | 14 | 15 | 16 | 17 | 18 | 19 | 20 |

[symbol]

Year

| | | | | | | | | | | |
|---|---|---|---|---|---|---|---|---|---|---|
| 1 | −0.552% | −0.117% | 0.259% | 0.585% | 0.860% | 1.122% | 1.348% | 1.549% | 1.732% | 1.897% |
| 2 | 0.309% | 0.6 7% | 0.923% | 1.174% | 1.309% | 1.601% | 1.781% | 1.945% | 2.095% | 2.231% |
| 3 | 0.938% | 1.198% | 1.423% | 1.627% | 1.810% | 1.975% | 2.125% | 2.262% | 2.388% | 2.503% |
| 4 | 1.416% | 1.627% | 1.815% | 1.986% | 2. [symbol] % | 2.278% | 2.405% | 2.523% | 2.630% | 2.730% |
| 5 | 1.793% | 1.972% | 2.132% | 2.277% | 2.4 [symbol] % | 2.528% | 2.639% | 2.741% | 2.835% | 2.922% |
| 6 | 2.100% | 2.255% | 2.394% | 2.519% | 2. [symbol] % | 2.740% | 2.838% | 2.927% | 3.010% | 3.088% |
| 7 | 2.357% | 2.491% | 2.614% | 2.725% | 2. [symbol] % | 2.922% | 3.009% | 3.089% | 3.164% | 3.233% |
| 8 | 2.575% | 2.696% | 2.805% | 2.904% | 2.056% | 3.080% | 3.158% | 3.231% | 3.299% | 0.302% |
| 9 | 2.764% | 2.873% | 2.972% | 3.063% | 3.146% | 3.222% | 3.293% | 3.359% | 3.420% | 3.478% |
| 10 | 2.832% | 3.032% | 3.122% | 3.205% | 3.281% | 3.352% | 3.416% | 3.477% | 3.533% | 3.586% |
| 11 | 3.082% | 3.175% | 3.259% | [symbol] | 3.406% | 3.4 [symbol] % | 3.531% | 3.587% | 3.839% | 3.688% |
| 12 | 3.219% | 3.306% | 3.384% | [symbol] | 3.522% | 3.582% | 3.639% | 3.691% | 3.740% | 3.786% |
| 13 | 3.345% | 3.427% | 3.501% | 3.568% | 3.631% | 3.688% | 3.741% | 3.795% | 3.837% | 3.879% |
| 14 | 3.462% | 3.540% | 3.811% | 3.675% | 3.731% | 3.789% | 3.839% | 3.886% | 3.930% | 3.971% |
| 15 | 3.570% | 3.646% | 3.714% | 3.776% | 3.83 [symbol] % | 3.885% | 3.934% | 3.979% | 4.021% | 4.080% |
| 16 | 3.0671% | 3.744% | 3.811% | 3.871% | 3.9 [symbol] % | 3.977% | 4.024% | 4.067% | 4.108% | 4.145% |
| 17 | 3.764% | 3.836% | 3.901% | 3.962% | 4. [symbol] % | 4.064% | 4.110% | 4.152% | 4.191% | 4.228% |
| 18 | 3.851% | 3.923% | 3.987% | 4.045% | 4. [symbol] % | 4.148% | 4.192% | 4.234% | 4.272% | 4.308% |
| 19 | 3.934% | 4.004% | 4.068% | 4.128% | 4. [symbol] % | 4.228% | 4.272% | 4.313% | 4.351% | 4.387% |
| 20 | 4.011% | 4.082% | 4.146% | 4.204% | 4.25 [symbol] % | 4.306% | 4.350% | 4.391% | 4.420% | 4.485% |

TABLE 2
Bi-week Payroll Deduction Standard Option Premium for Medical Expense Reinbursement at $1,000 Maxium per Year
Number of years to enroll and to be paid out

| | 1 | 2 | 3 | 4 | 5 | 6 | 7 | 8 | 9 | 10 |
|---|---|---|---|---|---|---|---|---|---|---|
| Paid-in years | | | | | | | | | | |
| 1 | 71.50 | 122.97 | 1 [symbol] | 205.83 | 246.10 | 284.11 | 320.32 | 354.97 | 387.71 | 418.78 |
| 2 | 20.50 | 50.00 | 73.21 | 94.01 | 113.71 | 132.09 | 150.00 | 166.69 | 182.58 | 197.50 |
| 3 | 15.98 | 20.97 | 45.15 | 68.48 | 71.08 | 82.64 | 94.11 | 104.76 | 114.82 | 124.40 |
| 4 | 11.30 | 21.91 | 31.92 | 41.34 | 50.20 | 58.72 | 66.71 | 74.27 | 81.48 | [symbol] |
| 5 | 8.62 | 10.68 | 24.30 | 31.47 | 38.23 | 44.62 | 60.60 | 68.38 | 51. [symbol] | [symbol] |
| 6 | 6.90 | 13.31 | 18.20 | 25.05 | 30.40 | 35.40 | 40.23 | 44.75 | 49.02 | [symbol] |
| 7 | 5.09 | 10.97 | 15.02 | 20.57 | 24.94 | 29.05 | 32.94 | 36.60 | 40.07 | 43.05 |
| 8 | 4.81 | 9.26 | 13.40 | 17.20 | 20.83 | 24.36 | 27.58 | 30.02 | 33.49 | 36.21 |
| 9 | 4.14 | 7.94 | 11.40 | 14.70 | 17.89 | 20.79 | 23.51 | 20.07 | 28.49 | 30.77 |
| 10 | 3.61 | 6.91 | 9.98 | 12.84 | 15.50 | 17.99 | 20.33 | 22.52 | 24.58 | 26.52 |
| 11 | 3.18 | 6.09 | 8.77 | 11.27 | 13.69 | 15.76 | 17.70 | 19.68 | 21.46 | 20.13 |
| 12 | 2.83 | 5.41 | 7.79 | 9.99 | 12.04 | [symbol] | 15.71 | 17.37 | 18.92 | 20.37 |
| 13 | 2.54 | 4.84 | 6.97 | 8.93 | 10.75 | 12.43 | 14.00 | 15.43 | 16.02 | 15.09 |
| 14 | 2.29 | 4.36 | 6.27 | 8.03 | 9.66 | 11.18 | 12.56 | 13.85 | 15.06 | 16.19 |
| 15 | 2.08 | [symbol] | 5.08 | 7.27 | 8.73 | 10.09 | 11.94 | 12.50 | 13.57 | 14.57 |
| 16 | 1.09 | 3.60 | 5.17 | 6.61 | 7.94 | [symbol] | 10.26 | 11.00 | 12.00 | 13.20 |
| 17 | 1.70 | 3.30 | 4.73 | 6.04 | 7.25 | 8.30 | 9.28 | 10.33 | 11.20 | 12.01 |
| 18 | 1.59 | 3.03 | 4.34 | 5.54 | 6.05 | 7.66 | 8.00 | 9.40 | 10.23 | 10.98 |
| 19 | 1.47 | 2.79 | 3.09 | 5.10 | 6.12 | 7.05 | 7.90 | 8.69 | 8.41 | 10.08 |
| 20 | 1.38 | 2.57 | 3.68 | 4.71 | 6.84 | 6.60 | 7.20 | 8.01 | [symbol] | 9.28 |
| | 11 | 12 | 13 | 14 | 15 | 16 | 17 | 18 | 19 | 20 |
| Paid-in years | | | | | | | | | | |
| 1 | 446.43 | 476.43 | 502.93 | 528.17 | 552.08 | 574.49 | 595.88 | 618.07 | 636.11 | 653.15 |
| 2 | 211.80 | 225.04 | 238.14 | 250.14 | 261.74 | 272.02 | 262.90 | 292.64 | 301.08 | 310.57 |
| 3 | 133.46 | 142.07 | 150.22 | 157.10 | 165.28 | 172.21 | 174.76 | 185.02 | 190.93 | 196.49 |
| 4 | 94.72 | 100.94 | 106.66 | 112.17 | 117.38 | 122.04 | 127.04 | 131.49 | 135.71 | 139.71 |
| 5 | 71.84 | [symbol] | 60.06 | 85.10 | [symbol] | 92.74 | 90.30 | [symbol] | 102.89 | 105.93 |
| 6 | 58.90 | 60.64 | 63.99 | 67.17 | 70.37 | 77.33 | 70.13 | 78.70 | 81.31 | 83.71 |
| 7 | 46.46 | 49.40 | 52.19 | 54.14 | 57.30 | 59.74 | 62.01 | 64.10 | 60.20 | 68.14 |
| 8 | 38.77 | 41.21 | 43.51 | 45.69 | 47.77 | 49.73 | 51.60 | 63.37 | 65.05 | 66.65 |
| 9 | 32.93 | 34.07 | [symbol] | 38.73 | 40.46 | 42.10 | 43.00 | 45.14 | 46.66 | 47.89 |
| 10 | 28.36 | 30.09 | 31.70 | 33.28 | 34.74 | 36.13 | 31.49 | 38.70 | 39.89 | 41.02 |
| 11 | 24.71 | 26.19 | 27.59 | [symbol] | 30.17 | 31.36 | 32.49 | 33.06 | 34.58 | 35.62 |
| 12 | 21.74 | 23.02 | 24.24 | 25.23 | 26.44 | 27.40 | 28.45 | 29.38 | 30.20 | 31.05 |
| 13 | [symbol] | 20.41 | 21.47 | [symbol] | 23.40 | 24.29 | 25.12 | [symbol] | 26.66 | 27.37 |
| 14 | 17.24 | 18.20 | 19.15 | 20.00 | 20.54 | 21.62 | 22.34 | [symbol] | 23.80 | 24.65 |
| 15 | 15.51 | 16.30 | 17.20 | 17.97 | 18.69 | 19.39 | 10.17 | 20.91 | 21.62 | 22.29 |
| 16 | 14.03 | 14.81 | 15.54 | 16.22 | 16.94 | 17.88 | 18.40 | 18.97 | 19.72 | 20.33 |
| 17 | 12.76 | 13.46 | 14.11 | 14.79 | 15.51 | 16.19 | 16.84 | 17.48 | 18.05 | 18.62 |
| 18 | 11.68 | 12.28 | 12.89 | 13.58 | 14.24 | 14.87 | 16.47 | 15.04 | 16.59 | 17.10 |
| 19 | 10.69 | 11.28 | 11.97 | 12.61 | 13.12 | 13.70 | 14.26 | 14.70 | 15.28 | 15.75 |
| 20 | 9.84 | 10.36 | 10.97 | 11.58 | 12.12 | 12.65 | 13.16 | 13.85 | 14.11 | 14.66 |

Lump Sum Premium for Medical Expense Reinbursement at $1,000 Maxium per Year
Number of years benefit [symbol] be paid out

| | | | | | | | | | |
|---|---|---|---|---|---|---|---|---|---|
| 1 | 2 | 3 | 4 | 5 | 6 | 7 | 8 | 9 | 10 |

Elimination Years

| 1 | [symbol] | 2,087.21 | 4,142.05 | 5,237.09 | 6,284.34 | 7,200.76 | 8,100.05 | 9,085.98 | 9,892.33 | 10,669.12 |
|---|---|---|---|---|---|---|---|---|---|---|
| 2 | [symbol] | [symbol] | 3,807.24 | 4,866.25 | 5,869.73 | 6,704.80 | 7,682.48 | 8,517.30 | 9,302.64 | 10,047.44 |
| 3 | 1,416.88 | 2,539.62 | 3,586.20 | 4,590.50 | 5,531.48 | 6,421.08 | 7,250.70 | 8,047.73 | [symbol] | 9,501.38 |
| 4 | 1,361.58 | 2,428.83 | 3,424.79 | 4,363.28 | 5,260.74 | 6,089.71 | 6,841.02 | 7,801.79 | 8,338.60 | 9,004.40 |
| 5 | 1,312.05 | 2,020.17 | 3,285.40 | 4,157.72 | 4,998.33 | 6,760.27 | 6,509.20 | 7,247.40 | 7,914.94 | 8,548.11 |
| 6 | 1,262.20 | 2,221.54 | 3,119.22 | 3,962.74 | 4,758.94 | 5,511.01 | 6,220.26 | 6,888.71 | 7,520.46 | 8,117.57 |
| 7 | 1,217.20 | 2,127.41 | 2,977.65 | 3,779.39 | 4,633.94 | 5,244.78 | 6,016.94 | 6,660.41 | 7,148.24 | 7,711.54 |
| 8 | 1,172.49 | 2,037.04 | 2,846.02 | 3,804.82 | 4,316..44 | 4,993.09 | 6,628.57 | 6,227.61 | 6,792.92 | 7,326.90 |
| 9 | 1,136.23 | 1,652.24 | 2,716.64 | 3,438.51 | 4,115.87 | 4,763.18 | 5,353.64 | 5,821.22 | 6,456.07 | 4,959.70 |
| 10 | 1,089.66 | 1,869.88 | 2,598.17 | 2,260.34 | 3,920.70 | [symbol] | 5,002.07 | 5,620.04 | 6,132.87 | 6,609.50 |
| 11 | 1,050.55 | 1,782.64 | 2,482.57 | 3,128.52 | 3,735.61 | 4,305.83 | 4,842.12 | 5,348.23 | 5,824.57 | 6,273.00 |
| 12 | 1,013.78 | 1,717.84 | 2,372.32 | 2,964.37 | 3,667.88 | [symbol] | 4,603.50 | 5,079.88 | 5,528.76 | 5,951.67 |
| 13 | 970.20 | 1,647.05 | 2,267.21 | 2,714.28 | 3,388.32 | 3,896.78 | 4,374.13 | 4,823.45 | 5,245.61 | 5,842.76 |
| 14 | 944.53 | 1,679.38 | 2,168.57 | 2,714.28 | 3,225.88 | 3,705.45 | 4,155.27 | 4,677.08 | 4,974.18 | 5,347.10 |
| 15 | 912.57 | 1,614.05 | 2,071.08 | 2,688.05 | 3,071.19 | 3,522.00 | 3,945.50 | 4,342.10 | 4,710.92 | 5,082.00 |
| 16 | 881.93 | 1,463.73 | 1,979.80 | 2,486.71 | 2,923.67 | 3,340.79 | 3,746.08 | 4,118.05 | 4,466.73 | 4,793.42 |
| 17 | 853.11 | 1,395.01 | 1,890.62 | 2,354.71 | 2,783.76 | 3,183.20 | 3,556.35 | 3,904.00 | 4,231.00 | [symbol] |
| 18 | 825.52 | 1,340.20 | 1,811.31 | 2,246.84 | 2,660.42 | 3,026.10 | 3,375.58 | 3,702.10 | 4,006.62 | 4,291.04 |
| 19 | 799.42 | 1,287.75 | 1,703.46 | 2,143.95 | 2,524.05 | 2,876.37 | 3,204.10 | 3,500.02 | 3,793.24 | 4,058.62 |
| 20 | 774.69 | 1,237.67 | 1,659.28 | 2,048.49 | 2,400.65 | 2,704.18 | 3,040.62 | 3,325.05 | 3,589.93 | 3,636.46 |
| | 11 | 12 | 13 | 14 | 15 | 16 | 17 | 18 | 19 | 20 |

Elimination Years

| | | | | | | | | | | |
|---|---|---|---|---|---|---|---|---|---|---|
| 1 | 11,406.05 | 12,098.89 | 12,750.79 | 13,365.84 | 13,945.76 | 14,490.01 | 15,001.39 | 15,483.86 | 15,935.21 | 26,360.26 |
| 2 | 10,748.69 | 11,408.12 | 12,030.70 | 12,017.64 | 13,169.02 | 13,007.30 | 14,170.66 | 14,035.73 | 15,066.50 | 15,471.63 |
| 3 | 10,164.91 | 10,791.73 | 11,382.94 | 11,938.81 | 12,461.60 | 12,955.52 | 13,4169.51 | 13,855.29 | 14,264.73 | 14,160.49 |
| 4 | [symbol] | 10,227.74 | 10,766.71 | 11,312.80 | 11,809.51 | 12,276.97 | 12,710.38 | 13,129.31 | 13,616.43 | 13,084.17 |
| 5 | [symbol] | 9,702.86 | 10,231.16 | 10,729.94 | 11,198.02 | 11,642.02 | 12,067.78 | 12,449.12 | 12,812.78 | 13,164.16 |
| 6 | 8,880.19 | 9,210.22 | 9,710.07 | 10,182.21 | 10,620.30 | 11,044.18 | 11,437.31 | 11,807.93 | 12,156.81 | 12,484.36 |
| 7 | 8,242.05 | 8,746.15 | 9,219.40 | 9,665.01 | 10,084.49 | 10,479.30 | 10,850.89 | 11,201.01 | 11,530.87 | 11,840.78 |
| 8 | 7,629.88 | 8,303.60 | 8,751.03 | 9,173.02 | 9,670.22 | 9,644.02 | 10,296.75 | 10,626.65 | 10,937.63 | 11,230.73 |
| 9 | 7,435.12 | [symbol] | 8,005.85 | 8,703.30 | 8,078.86 | 8,432.46 | 9,705.14 | 10,078.12 | 10,372.63 | 10,649.48 |
| 10 | 7,058.18 | 7,400.47 | 7,679.41 | 8,265.01 | 8,408.45 | 8,941.40 | 9,255.88 | 9,651.19 | 9,829.20 | 10,090.77 |
| 11 | 6,696.52 | 7,095.29 | 7,370.45 | 7,820.96 | 8,157.33 | 8,470.91 | [symbol] | 9,044.43 | 9,306.52 | 9,553.05 |
| 12 | 6,549.60 | 6,724.90 | 7,078.15 | 7,410.55 | 7,723.32 | 8,918.45 | 8,295.90 | 8,656.00 | 8,803.31 | 9,036.16 |
| 13 | 6,017.16 | 6,369.20 | 6,700.06 | 7,013.09 | 7,306.73 | 7,582.64 | 7,643.46 | 8,088.26 | 8,318.71 | 8,536.36 |
| 14 | 5,697.60 | 6,027.60 | 6,338.31 | 6,630.53 | 6,505.67 | 7,164.16 | 7,407.54 | 7,630.69 | 7,652.07 | 8,055 08 |
| 15 | 5,391.86 | 5,700.32 | 5,990.61 | 6,263.24 | 6,620.17 | 6,761.64 | [symbol] | 7,202.11 | 7,402.88 | 7,501.97 |
| 16 | 5,100.44 | 5,384.24 | 5,669.02 | 5,913.21 | 6,152.26 | 6,377.12 | 6,588.22 | 6,787.02 | 6,973.01 | 7,149.41 |
| 17 | 4,822.06 | 5,091.00 | 5,342.93 | 5,579.36 | 5,601.43 | 6,010.14 | 6,208.23 | 6,390.66 | 6,663.63 | 6,724.46 |
| 18 | 4,660.10 | 4,807.91 | 5,041.82 | 5,261.20 | 5,407.06 | 5,660.18 | 5,841.73 | 6,012.03 | 6,172.25 | 6,322.34 |
| 19 | 4,306.28 | [symbol] | [symbol] | 4,957.84 | 5,148.27 | 6,326.62 | 6,493.94 | 5,851.09 | 5,798.31 | 5,936.00 |
| 20 | [symbol] | 4,200.60 | [symbol] | 4,600.54 | 4,840.90 | 6,008.18 | 6,162.07 | 5,306.97 | 5,440.37 | 5,565.85 |

The CPU 12 and the memory device 14 may cooperate to encode signals defining means by which premium (pricing) and benefit payout data are determined in the preferred embodiments of the present invention. The signals can be part of a stored program, but the signals can also be identified as macros or subroutines within the at least one workbook. In the implementation as a macro, these signals in effect provide look-up tables keyed to particular input parameters according to a standard credited interest rate algorithm or a lump sum credited interest rate algorithm so that premium and payout benefit data are obtained from predetermined numerical data in the assumptions sheet in response to particular input data.

Alternatively, means by which premium and benefit payout information are obtained can be implemented with mathematical equations encoded and stored in the memory and defined by parameters corresponding to assumption variables stored within a database. The computer system 10 solves these equations using specific input data to obtain corresponding premium and benefit payout information. The database and equation implementations can be used separately or in combination.

At least one output device 18 includes any suitable device or combination of devices. As shown FIG. 1, an example of a preferred embodiment is a cathode ray tube (CRT) monitor 18a. A particularly desired device is a printer 18b, which is the output device specifically identified in FIG. 1.

The components of the digital computer system represented in FIG. 1 can be particularly implemented by any suitable devices capable of performing the digital data processing of the present invention. The computer system of a particular implementation is preferably a personal computer, but it is contemplated that any other class (e.g., microcomputer, minicomputer, mainframe) of computer can be used if it includes suitable components to handle the quantity of data and desired operating speed. It is to be noted that the invention can be implemented with systems having single (as shown in FIG. 1) or multiple central processing units and associated devices. Multiple systems can have the respective subsystems utilized within one or more networks or individually.

The computer system 10 preferably displays results on the monitor 18a to illustrate the plurality of spreadsheets, FIGS. 5-6, and 9.

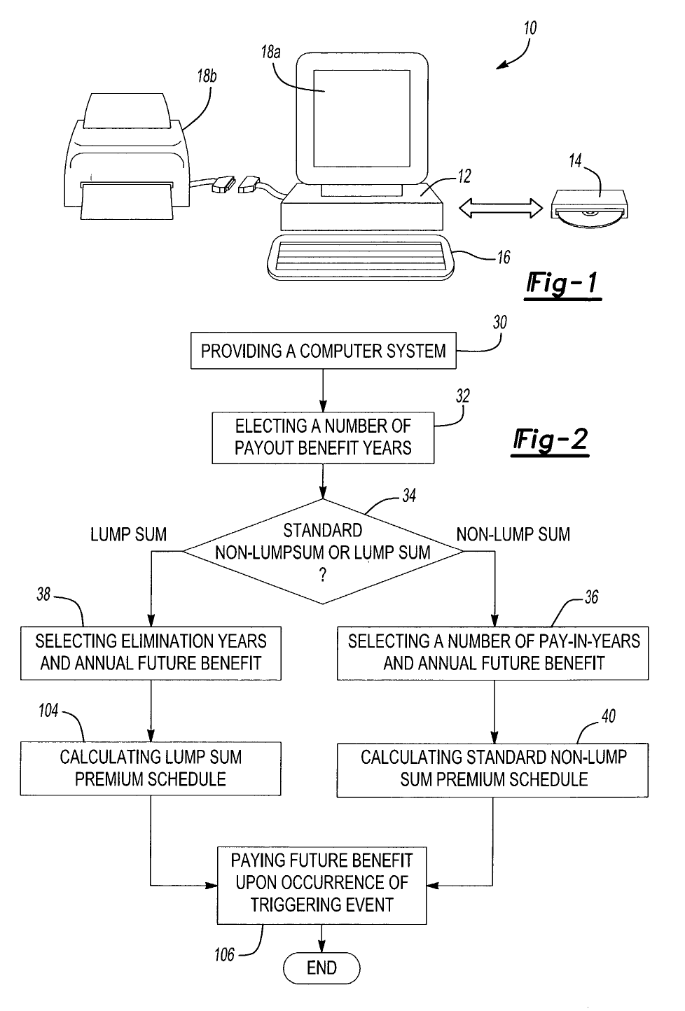

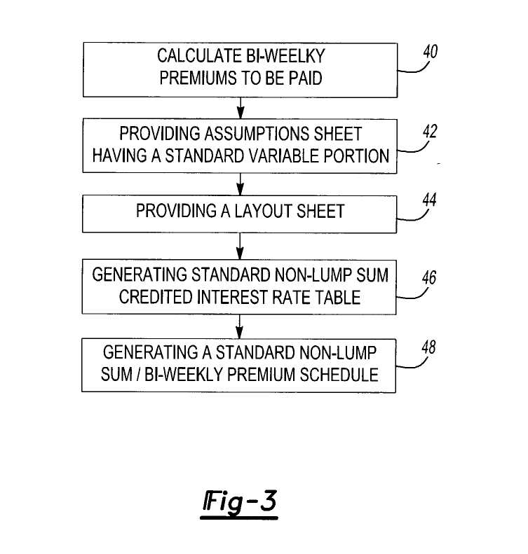

A method of using the present invention will now be described with reference to the flowchart of FIGS. 2 and 3. As mentioned, this method can be implemented using the digital computer system of FIG. 1.

The method of FIG. 2 operates as follows. The first step in designing the senior lifestyles benefit plan is to preferably provide a digital computer system (step 30), such as the digital computer system 12 having a data processing program to manipulate and process a plurality of variables input into the program. An employee or covered person first elects a number of payout benefit years (step 32), wherein the number of payout years is selected from the group l under the standard non-lump-sum premium option and r under a lump sum premium option. Next, the covered person elects a premium pay-in option (step 34), wherein the pay-in option consists of the group selected from a standard non-lump-sum premium option and a lump sum premium option. If the standard non-lump-sum option is selected, then, a number of pay-in years, k for an associated number of payout years l, and an annual maximum benefit amount, B, must be elected by the employee (step 36). If the lump sum premium option is selected, then, a number of deferred or elimination years, q for an associated number of lump sum payout years r, and a lump sum annual maximum benefit amount, LB, must be elected by the employee (step 38). After the employee elections have been made for a specific employee, the data is input into the senior lifestyles software program to calculate a schedule of premiums to be paid based on at least one of the standard non-lump-sum variables (step 40) and the lump sum variables to obtain a future paid benefit (step 104). The final step (106) includes paying a maximum benefit amount for qualified health expenses incurred by an eligible covered person upon occurrence of a triggering event.

Under the standard non-lump-sum option, a preferred method requires that an employee elect an annual maximum benefit amount, a premium pay-in period after electing a payout period, l (step 36). Preferably, the number of pay-in years, k, within a premium pay-in period preferably ranges from 1 to 20 years and the number of payout years, l, within a benefit payout period also, preferably ranges from 1 to 20 years. Premiums under the standard non-lump-sum option will be paid during a pay-in period equaling the number of years that premiums are paid to the insurance company in accordance with the method of the present invention. The plan period begins from the beginning of the pay-in period k and continues through the end of the predefined payout period l.

Alternatively, under the lump sum option, a preferred method requires that an employee elect an annual maximum benefit amount, an elimination period, after electing a benefit payout period, r (step 38). The lump sum option is a premium payment and a benefit option wherein all premiums will be paid within a predefined period, preferably within the first three months of the plan's effective date. When this option is selected, a predefined elimination period, q, begins. The elimination period q is a time period measured by a number of deferred years before benefits can be received under the lump sum option, wherein the elimination period is used in place of the pay-in period k. An employee waits for the number of deferred years equal to the elimination period q until the employee is eligible to receive benefits. The number of deferred years within an elimination period q preferably ranges from 1 to 20 years. The number of payout years within a benefit payout period r also, preferably ranges from 1 to 20 years. The plan period under the lump sum option begins from the beginning of the elimination period q and continues through the end of the predefined payout period r.

Preferably, bi-weekly premiums associated with pay-in years k, and payout years l are calculated if the standard non-lump-sum option is selected (step 40). Alternatively, lump sum premiums associated with elimination years q, and lump sum payout years rare preferably calculated if the lump sum option is selected (step 128).

An employee covered under the senior lifestyles benefit plan will be eligible for benefits under either the standard lump sum premium option or the lump sum premium option when a triggering event occurs (step 106).

As shown in FIG. 3, the step of calculating premiums under the standard non-lump-sum premium option (step 40), preferably includes the step of calculating bi-weekly premiums to be paid to an insurance company offering the senior lifestyle benefit plan during the pay-in period k based on a credited interest rate, i^{c}. However, an alternative formula (not shown) could be used to determine premiums to be paid using an alternative payment schedule such as in weekly or in monthly installments.

As shown in FIG. 3, the step of calculating bi-weekly premiums under the standard non-lump-sum premium option (step 40) further has the steps of:

a. providing an assumptions spreadsheet 22 having a standard non-lump-sum assumptions portion 24 (step 42);

b. providing a layout spreadsheet 28 by importing standard assumption variables from the standard portion 24 of the assumptions spreadsheet 22 into the layout spreadsheet 28 using a plurality of embedded commands programmed within a plurality of cells within the layout sheet 28 (step 44);

c. generating a standard credited interest rate table (Table 1) using a standard credited interest rate algorithm (step 46), the standard credited interest rate algorithm being one of the plurality of embedded commands programmed within the plurality of cells within the layout sheet; and

d. generating a bi-weekly premium schedule of bi-weekly contributions (Table 2) based on the standard credited interest rate table generated in step c (step 48).

The method of providing the assumption spreadsheet 22 (step 42) further has the step of defining standard assumption variables (the standard assumption variables are shown in the standard option portion 24 of the assumption sheet 22 in FIG. 5) within the standard non-lump-sum portion 24 of the assumptions spreadsheet 22 (step 50, not shown). Preferably, the standard assumption variables provide: a plurality of mortality rates for a male associated with a number of policy years, the plurality of mortality rates are obtained from the Society of Actuaries (SOA) Final Report of the Individual Life Insurance Valuation Mortality Task Force, 2001 Basic Mortality Table, Male Composite 2001 Valuation Basic Table, based an average issue age of 62, however, a different mortality rate table may be selected to customize the plan according to requirements of a different employee; an annual lapse rate of 10%; an early retirement rate of 1% annually; a net investment return rate i of 5.0%; an initial fixed expense of $1.00 per $1,000 of annual maximum benefit; an annual maximum benefit of $1,000.00; a commission of 4% annually; administration fees including a pay-in period administration rate of 8%, the pay-in period administration fee is incurred during pay-in years as a certain percentage of collected premiums, wherein the pay-in administration fee is labeled Admin 1 in cell (I, 5) of the assumptions sheet; a payout period administration of 7%, wherein the payout period administration fee is incurred during payout years as a certain percentage of a paid benefit, and wherein the payout administration fee is labeled Admin 2 in cell (J, 5) of the assumption sheet; a premium tax rate of 2.5%; and a profit objective or goal of 6%, wherein the profit goal of 6% is calculated using a present value of profits, PVᵢ (profit), discounted at the net investment return rate i, divided by a present value of premiums, PVᵢ (premium), discounted at the net investment return rate of i. Additionally, the insurance company must pay a corporation tax preferably, at a rate of 34% on profits obtained from employees insured under the plan offered by the insurance company.

Preferably, the step of providing the layout spreadsheet 28 (step 44) further provides the step of:

providing a plurality of columns having a plurality of associated rows defined by the plurality of associated cells, wherein each associated row within the plurality of associated rows represents a policy year (as shown in FIG. 6), preferably ranging from 0 years to 40 years, as shown in rows 11-51 of FIG. 6, and wherein the plurality of columns further has:

a column A, B, C, D, E, F, G, and H, wherein columns A-H define standard assumption variables imported from the assumptions sheet values used to price standard premium payments, wherein

column A defines a predefined number of policy years, preferably ranging from 1 to 40, wherein policy years 1 to k are preferably, pay-in years, and wherein k preferably ranges from 1 to 20, and wherein policy years k+1 to k+l are preferably, payout years, wherein l preferably ranges from 1 to 20;

column B defines a plurality of mortality rates for an average issue age of 62 associated with each policy year,

column C defines a lapse rate associated with a specific pay-in year,

column D defines an early retirement rate associated with each policy year,

column E defines a survival rate for each policy year,

column F defines an effective or net investment return rate i.

column G defines a credited interest rate i^{c}, wherein the credited interest rate is calculated by performing a credited interest rate algorithm, and

column H defines an expense associated with each policy year for providing the plan to a covered person;

a column I, column I for defining a plurality of bi-weekly premium rates calculated from associated values stored within columns A through H;

a column J, column J for defining a present value (PVi) of a current year's premium, wherein the PVi is calculated at the end of an associated pay-in year;

a column K, column K for defining an expected paid benefit due to death, wherein if a death occurs during the pay-in years, then a covered person or entity receives a return of 100% of collected premiums, and wherein, if death occurs during the standard payout years, a covered person's estate or surviving spouse has access to a remaining benefit;.

a column L, column L for defining an expected future value of a pro-rated benefit at an end of the pay-in period, minus a lapse charge, and wherein the pro-rated expected future value equals a present value of collected premiums, PVi^{c}, at time 0 (zero) of a predefined payout period, and the lapse charge equals the unearned pay-in Admin 1 fee, preferably, 8% of the scheduled premium;

a column M, column M for defining an expected annual benefit due to lapses in premium payments, wherein the expected annual benefit calculated during a pay-in year is the unearned administration fee based on the premium rate, Admin 1 fee, and is paid to an insurance company, wherein, the expected annual benefit calculated during a payout year of a maximum benefit is a level payment amount obtained from the total pro-rated benefit computed in Col. L, discounted at i^{c}, and wherein a probability of mortality for the payout period is ignored;

a column N, column N for defining a pro-rated maximum annual benefit due to early retirement;

a column O, column O for defining a summation of ranges for Col. P;

a column P, column P for defining an expected annual benefit due to early retirement associated with a policy year;

a column Q, column Q for defining an expected annual benefit, wherein the expected annual benefit during an associated pay-in year is the summation of values within associated cells within columns K, M, and P representing benefits paid to pre-matured policies, and wherein the expected annual benefit during an associated payout year is a sum of the expected benefit amount, the expected benefit amount equaling the probability that plan is still in force multiplied by $1,000.00 and the summation of values within associated cells within columns K, M, and P;

a column R, column R for defining an expected annual expense level, wherein during pay-in years, the expected annual expense level is a premium value obtained from Col. J times a pay-in Admin 1 rate, and an initial fixed expense for first year; during payout years, the expected annual expense level is an associated benefit value obtained from Col. Q times a payout Admin 2 rate;

a column S, column S for defining an accumulated asset value, wherein the accumulated asset value is last year's asset value accrued at the net investment return rate i, plus the associated premium value obtained from Col. J, minus benefit and expense values obtained from columns Q and R, respectively;

a column T, column T for defining a benefit reserve, wherein the benefit reserve is a previous year's asset value accrued at i^{c}, plus a current year's premium accrued at i^{c}, minus a benefit value obtained from Col. Q during an associated pay-in year, and wherein, the benefit reserve is the sum of future benefit discounted at i^{c} during an associated payout year;

a column U, column U for defining an expected pre-tax profit, the expected pre-tax profit equaling an asset value minus the associated benefit reserve from Col. T;

a column V, column V for defining a tax on premium profits; and

a column W, column W for defining an after-tax profit value.

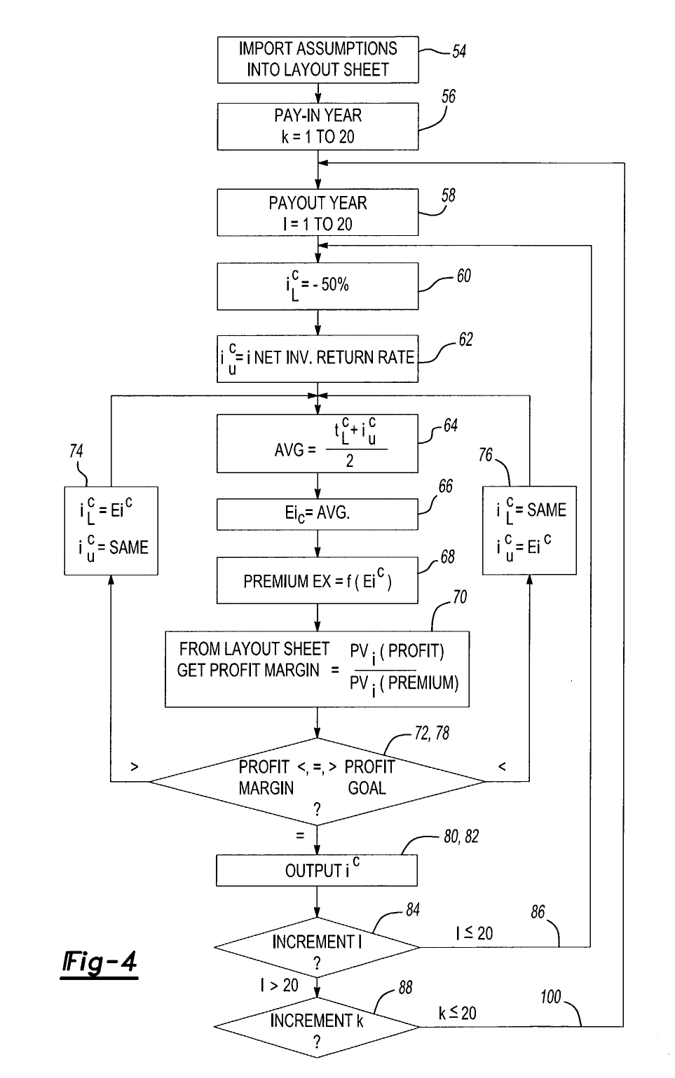

As shown in FIGS. 3-4, the step of generating a standard credited interest rate table using a standard credited interest rate algorithm (step 46) provides the steps of:

1. importing standard non-lump-sum assumption variables into the layout sheet 28 (step 54);

2. initially setting a pay-in year k equal to 1 (step 56);

3. initially setting a payout year l equal to 1 (step 58);

4. initially setting a lower bound i^{c}_{L} of an estimated standard credited interest rate Ei^{c} equal to a lower bound percentage, preferably −50% (step 60), and setting i^{c}_{U} equal to a net investment return rate i imported from the assumptions sheet 22 (step 62);

5. calculating the estimated credited interest rate Ei^{c} for an associated pay-in year k and an associated payout year l, wherein the step of calculating the estimated credited interest rate Ei^{c} for an associated pay-in year k and an associated payout year l provides the following substeps:

a. averaging i^{c}_{L} and i^{c}_{U}, by adding i^{c}_{L} and i^{c}_{U} and then dividing the sum by 2 (substep 64);

b. setting Ei^{c} equal to the average of i^{c}_{L} and i^{c}_{U} of step a (substep 66);

c. obtaining an estimated bi-weekly premium amount using the Ei^{c} from step 5b by calculating an estimated bi-weekly payroll deduction amount, eX, for a standard premium payment, wherein the estimated bi-weekly payroll deduction amount is calculated using a formula eX=ef(Ei^{c}), wherein

ef(Ei^{c})=B*[(1−(1+Ei^{c})^{-l})/(1−(1+Ei^{c})^{-k})]*[((1+Ei^{c})^{-1/13}−1)/Ei^{c}]*[(1+Ei^{c})^{(7/13)-k}] (substep 68);

d. importing a present value of profit, PVi (profit) from the layout sheet 28, discounted at the net investment rate, i, wherein the present value of profit is a summation of present values of a plurality of profits, the plurality of profits calculated within the layout sheet based on the Ei^{c} from step 5b, importing a present value of premium, PVi (premium) from the layout sheet 28, discounted at the net investment rate, i, wherein the present value of premium is a summation of present values of a plurality of premiums, the plurality of premiums calculated within the layout sheet based on the Ei^{c} from step 5b, and using the PVi (profit) and PVi (premium) to calculate a profit margin, wherein the profit margin equals PVᵢ(profit)/PVᵢ(premium) (substep 70);

e. comparing the profit margin from step 5d with a profit goal imported from the assumptions sheet 22 (substep 72);

f. recalculating Ei^{c} by setting i^{c}_{L} equal to the Ei^{c} from step 5b, and by keeping i^{c}_{U} unchanged if the profit margin is greater than the profit goal, thus raising the estimated credited interest rate to reduce the profit (substep 74),

g. recalculating Ei^{c} by keeping i^{c}_{L} unchanged, and by setting i^{c}_{U} equal to the Ei^{c} from step 5b if the profit margin is less than the profit goal, thus lowering the estimated credited interest rate (substep 76);

h. repeating steps a-g until the profit margin equals the profit goal (substep 78);

6. setting the standard credited interest rate i^{c} for the associated k and the associated l equal to the final Ei^{c} used in the last iteration of steps 5a-h when the profit margin equals the profit goal (step 80);

7. outputting i^{c} from step 6 into a credited interest rate table sheet (step 82);

8. incrementing l by one (step 84);

9. repeating steps 4-8 until l exceeds the maximum payout year, preferably 20 (step 86);

10. incrementing k by one (step 88); and

11. repeating steps 3-10 until k exceeds the maximum pay-in year, preferably 20 (step 100).

As shown in FIG. 3, the step of generating bi-weekly premium payments for insertion into a bi-weekly premium portion of a premium schedule (step 48) provides the step of:

inserting a calculated credited interest rate from the credited interest rate table for an associated pay-in year k and an associated payout year l into a bi-weekly premium payment formula (step 100, not shown), wherein the bi-weekly premium payment formula uses a benefit amount B, a credited interest rate i^{c} for each associated pay-in year k and payout year l, and wherein the bi-weekly premium payment formula equals B*[(1−(1+i^{c})^{-l})/(1−(1+i^{c})^{-k})]*[((1+i^{c})^{-1/13}−1)/i^{c}]*[(1+i^{c})^{(7/13)-k}] (step 102, not shown).

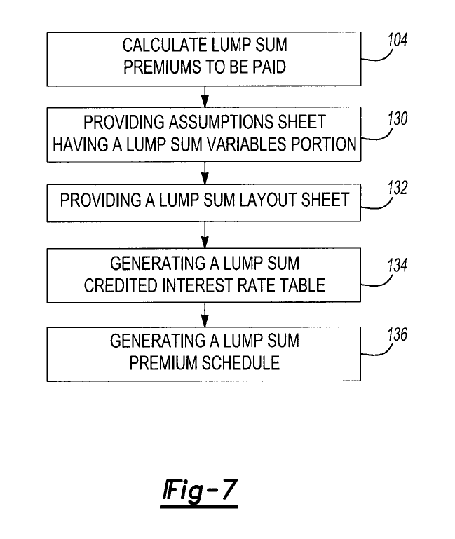

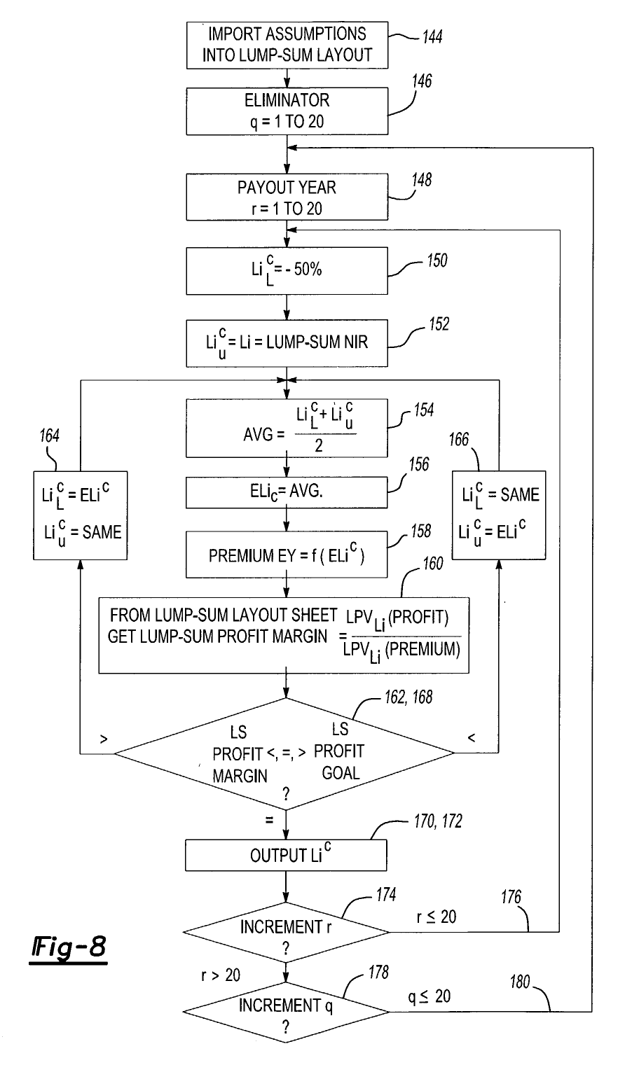

Alternatively, as shown in FIGS. 7-8, the step of calculating premiums under the lump sum option (step 104) is shown. The step of calculating premiums under the lump sum option (step 104) preferably includes the step of calculating premiums to be paid to an insurance company offering the senior lifestyles benefit plan during a first year of the elimination period q based on a lump sum credited interest rate Li^{c}:

As shown in FIG. 8, the step of calculating lump sum premiums under the lump sum option (step 104) further has the steps of:

a. providing an assumptions spreadsheet 22 having a lump sum assumptions portion 26 (step 130);

b. providing a lump sum layout spreadsheet 30 by importing lump sum assumption variables from the lump sum portion 26 of the assumptions spreadsheet 22 into the lump sum layout spreadsheet 30 using a plurality of embedded lump sum commands programmed within a plurality of lump sum cells within the lump sum layout sheet 30 (step 132);

c. generating a lump sum credited interest rate table (Table 1) using a lump sum credited interest rate algorithm (step 134), the lump sum standard credited interest rate algorithm being one of the plurality of embedded lump sum commands programmed within the plurality of lump sum cells within the lump sum layout sheet; and

d. generating a lump sum premium schedule of lump sum contributions (Table 2) based on the lump sum credited interest rate table generated in step c (step 136).

The method of providing the assumption spreadsheet 22 (130) further has the step of defining lump sum assumption variables (the lump sum assumption variables are shown in FIG. 5) within the lump sum portion 26 of the assumptions spreadsheet 22 (step 138, not shown). Preferably, the lump sum assumption variables provide: a plurality of mortality rates for a male associated with a number of policy years are obtained from the Society of Actuaries (SOA) Final Report of the Individual Life Insurance Valuation Mortality Task Force, 2001 Basic Mortality Table, Male Composite 2001 Valuation Basic Table, based an average issue age of 62, however, a different mortality rate table may be selected to customize the plan according to requirements of a different employee; a lump sum early retirement rate of 1% annual; a lump sum net investment return Li 5.5%; $1,000 of lump sum annual maximum benefit; a lump sum fixed expense of $100.00; a lump sum commission of 6%; lump sum administration fees including an elimination period administration rate of 7% for the first year of the lump sum premium option (shown in cell G11 of the lump sum layout sheet 30) and a lump sum deferred period administration rate of 0%, a lump sum payout period administration fee of 9%, a lump sum premium tax rate of 2.5%, and a lump sum profit goal of 9%, wherein the lump sum profit goal of 9% is calculated using a present value of lump sum profits, LPV_{Li} (profit), discounted at the lump sum net investment return rate Li, divided by a present value of lump sum premiums, LPV_{Li} (premium), discounted at the net investment return rate of Li.

Additionally, an insurance company must pay a lump sum corporation tax preferably, at a rate of 34% on profits obtained from employees insured under the plan offered by the insurance company.

Preferably, the step of providing the lump sum layout spreadsheet 30 (step 132) further provides the step of

providing a plurality of lump sum columns having a plurality of associated lump sum rows defined by the plurality of associated lump sum cells, wherein each associated lump sum row within the plurality of associated lump sum rows represents a policy year (as shown in FIG. 9), preferably ranging from 0 years to 40 years, as shown in rows 11-51 of FIG. 9, and wherein the plurality of columns further has:

columns A, D, E, F, G, and H, wherein columns A, and D-H define lump sum assumption variables imported from the assumptions sheet used to price lump sum premium payments, wherein

column A defines a predefined number of policy years, preferably ranging from 1 to 40, wherein policy years 1 to q are preferably, elimination years, and wherein q preferably ranges from 1 to 20, and wherein policy years q+1 to q+r are preferably, payout years, wherein r preferably ranges from 1 to 20;

column D defines an early retirement rate associated with each policy year,

column E defines an employee survival rate for each policy year,

column F defines a lump sum net investment return Li,

column G defines a lump sum credited interest rate Li^{c}, wherein the lump sum credited interest rate is calculated by performing a lump sum credited interest rate algorithm as defined in more detail below, and

column H defines an expense associated with each policy year for providing the plan to a covered person;

a column I, column I for defining a lump sum premium paid within the first year of the policy;

a column J, column J for defining a lump present value (LPV_{Li}) of one year's lump sum premium payment at a year end, the present value accumulated at the net investment return rate Li from investment;

a columns K, column K for defining values based on a premature event occurring wherein column K defines an expected paid benefit due to death, wherein if a death occurs during the elimination period, q, then a covered person or entity receives a return of 100% of collected premiums, and wherein, if death occurs during the lump sum payout years r, a covered person's estate or surviving spouse has access to a benefit amount up to LPV_{Li} (unpaid benefit of future years) in the year of death;

a column N, column N for defining a pro-rated maximum annual benefit due to early retirement;

a column O, column O for defining a summation of ranges for Col. P;

a column P, column P for defining an expected annual benefit due to early retirement associated with a policy year;

a column Q, column Q for defining an expected annual benefit, wherein during the elimination years the expected annual benefit is the sum of associated cells within column K and P, and during the payout years, the expected annual benefit is the sum of associated cells within columns K and P, plus the benefit amount, LB multiplied by the survival rate in the associated policy year;

a column R, column R for defining an expected annual expense level incurred during the elimination period and the payout period;

a column S, column S for defining an accumulated asset value, wherein the accumulated asset value is last year's asset value accrued at the lump sum net investment return rate Li,, minus benefit and expense values obtained from columns Q and R, wherein a year end value of a lump sum premium value from column J is added if the policy year is 1;

a column T, column T for defining a lump sum benefit reserve, wherein the lump sum benefit reserve is a previous year's asset value accrued at Li^{c}, minus a lump sum benefit value obtained from Col. Q during an associated elimination year, wherein, the lump sum benefit reserve is a present value of future lump sum benefits discounted at Li^{c}, and wherein a year-end value of a lump premium is added if the policy year is 1;

a column U, column U for defining an expected pre-tax profit, the expected pre-tax profit equaling an asset value minus the associated benefit reserve from Col. T;

a column V, column V for defining a tax on expected pre-tax profits; and

a column W, column W for defining an after-tax profit value.

As shown in FIGS. 7-8, the step of generating a lump sum credited interest rate table using a lump sum credited interest rate algorithm (step 134) provides the following steps:

1. importing lump sum assumption variables into the lump sum layout sheet 30 (step 144);

2. initially setting an elimination year q equal to 1 (step 146);

3. initially setting a payout year r equal to 1 (step 148);

4. initially setting a lump sum lower bound Li^{c}_{U} of an estimated standard credited interest rate ELi^{c} equal to a lump sum lower bound percentage, preferably −50% (step 150), and setting Li^{c}_{U} equal to a lump sum net investment return rate Li imported from the assumptions sheet 22 (step 152);

5. calculating the estimated lump sum credited interest rate ELi^{c} for an associated elimination year q and an associated lump sum payout year r, wherein the step of calculating the estimated lump sum credited interest rate ELi^{c} for an associated elimination year q and an associated payout year r provides the following substeps:

a. averaging Li^{c}_{L} and Li^{c}_{U}, by adding Li^{c}_{L} and Li^{c}_{U} and then dividing the sum by 2 (substep 154),

b. setting ELi^{c} equal to the average of Li^{c}_{L} and Li^{c}_{U} of step a (substep 156),

c. obtaining an estimated lump sum premium amount using the ELi^{c} from step 5b by calculating an estimated lump sum payroll deduction amount, eY, for a lump sum premium payment, wherein the estimated lump sum payroll deduction amount is calculated using a formula eY=ef(ELi^{c}), wherein

ef(ELi^{c})=LB*[(1−(1+ELi^{c})^{-r})/ELi^{c}]*(1+ELi^{c}) ^{1/2-q} (substep 158),

d. importing a present value of lump sum profits, LPV_{Li} (profit) from the lump sum layout sheet 30, discounted at the lump sum net investment rate, Li, wherein the present value of lump sum profits is a summation of present values of a plurality of lump sum profits, the plurality of lump sum profits calculated within the lump sum layout sheet based on the ELi^{c} from step 5b, and importing a present value of lump sum premiums, LPV_{Li} (premium) from the lump sum layout sheet 30, discounted at the lump sum net investment rate, Li, wherein the lump sum premium is calculated within the lump sum layout sheet based on the ELi^{c} from step 5b, and using the LPV_{Li} (profit) and LPV_{Li} (premium) to calculate a lump sum profit margin, wherein the lump sum profit margin equals LPV_{Li}(profit)/LPV_{Li} (premium) (substep 160),

e. comparing the lump sum profit margin from step 5d with a lump sum profit goal imported from the assumptions sheet 22 (substep 162),

f. recalculating ELi^{c} by setting Li^{c}_{L} equal to the ELi^{c} from step 5b, and by keeping Li^{c}_{U} unchanged if the lump sum profit margin is greater than the lump sum profit goal, thus raising the estimated lump sum credited interest rate to reduce the lump sum profit (substep 164),

g. recalculating Ei^{c} by keeping Li^{c}_{L} unchanged, and by setting Li^{c}_{U} equal to the ELi^{c} from step 5b if the profit margin is less than the profit goal, thus lowering the estimated credited interest rate (substep 166), and

h. repeating steps a-g until the lump sum profit margin equals the lump sum profit goal (substep 168);

6. setting the lump sum credited interest rate Li^{c} for the associated q and the associated r equal to the final ELi^{c} used in the last iteration of steps 5a-h when the profit margin equals the profit goal (step 170);

7. outputting Li^{c} from step 6 into a lump sum credited interest rate table sheet (step 172);

8. incrementing r by one (step 174);

9. repeating steps 4-8 until r exceeds the maximum payout year, preferably 20 (step 176);

10. incrementing q by one (step 178); and

11. repeating steps 3-10 until q exceeds the maximum elimination year, preferably 20 (step 180).

As shown in FIG. 7, the step of generating lump sum premium payments for insertion into a lump sum premium portion of a premium schedule (step 136) provides the step of:

inserting a calculated lump sum credited interest rate from the lump sum credited interest rate table (Table 1) for an associated elimination year q and an associated payout year r into a lump sum premium payment formula, wherein the lump sum premium payment formula uses a lump sum benefit amount LB, a lump sum credited interest rate Li^{c} for each associated elimination year q and payout year r, and wherein the lump sum premium payment formula equals LB*[(1−(1+Li^{c})^{-r})/Li^{c}]*(1+Li^{c})^{1/2-q} (step 105, not shown).

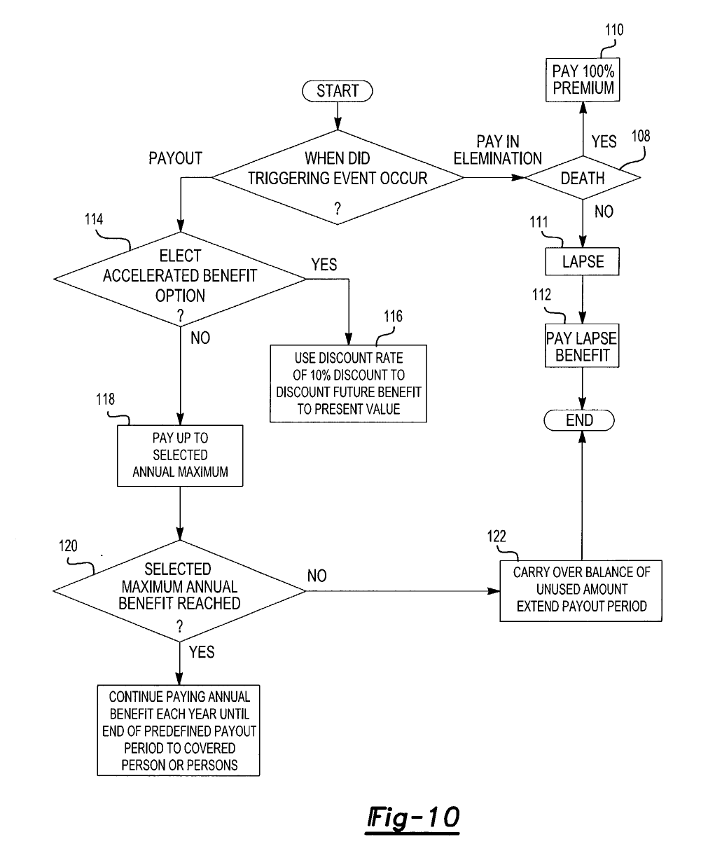

As shown in FIG. 2, once the premiums have been calculated for an associated future annual maximum benefit, the method further has the step of paying a benefit upon occurrence of a triggering event (step 106) during at least one of the elimination period and the pay-in period, or during the payout period. Future benefits cover qualified health expenses incurred by an eligible covered person upon occurrence of a triggering event (step 106) as shown in the flowchart of FIGS. 2 and 10. The triggering event is preferably selected from the group consisting of the employee's retirement, employee's total disability, employee's termination of employment, lapse in premium payments, and employee's death.

A covered person becomes eligible to receive benefits under the senior lifestyles benefit plan for a predefined payout period when a triggering event occurs. The payout period is the number of years that the selected annual benefit amount will be paid out.

Upon occurrence of the triggering event, benefits will be paid to the employee up to the selected annual benefit each year. Benefits will be paid up to the annual benefit amount each year during the payout period. Benefits paid cannot exceed the selected annual benefit amount for any one calendar year, unless, an accelerated benefit option is elected as described further below. The payout period will decrease on a pro-rata basis as benefits are used.

Preferably, a person retired under the plan is a person no longer actively at work as determined by the employer and is a person who no longer accrues vacation, sick or other paid leave.

A terminally ill person under the plan is preferably a person having a life expectancy of six months or less certified by a physician. A terminally ill person becomes a total disabled person when the person's employment stops due to the person's terminal illness.

Additionally, a total disability occurs under the plan when an employee cannot perform all of the duties of the employee's job or any job earning comparable pay, or upon award of social security disability benefits.

If the triggering event of death occurs (step 108) during either the pay-in period or the elimination period, then 100% of the paid premiums will be paid to a covered person or entity (step 110), preferably a spouse of the deceased employee, however a covered person or entity may be any person such as a dependent that qualifies under the IRS code as a dependent.

If the triggering event of a lapse occurs (step 111) during the pay-in period or the elimination period, then the required premiums were not paid to full term under the standard non-lump-sum option or the elimination period was shortened under the lump sum option. A benefit amount paid upon qualifying for the triggering event will be less if the premiums were not fully paid under the standard non-lump-sum option or if the elimination period is shortened under the lump sum option (step 112).

In one preferred embodiment, if a plan lapses under the standard lump sum option, the selected annual benefit will decrease to an adjusted selected annual benefit. An adjusted selected annual benefit will be determined by preferably, multiplying the result of a predefined pay-in period and a predefined payout period for a predefined premium schedule by 80% and then multiplying the results by the number of units of $1,000.00.

Alternatively, under the lump sum option, a plan can lapse if the required elimination period as defined under the plan is shortened. A benefit amount due upon qualifying for the triggering event will be less if the elimination period is shortened. The benefits received cannot exceed the selected annual benefit in any one calendar year, unless an accelerated benefit option is elected as described further below. The payout period will decrease on a pro-rata basis of any benefits used.

If the triggering event occurs during the payout period, then an option of choosing an optional accelerated benefit option is provided (step 114). The optional accelerated payout benefit option is provided to allow the employee planholder to elect to reduce the payout period for any reason such as an early retirement or a terminal illness event occurs. Early retirement includes termination of employment. It is assumed that the early retirement rate is constant and that the payout period starts right after the early retirement event occurs. The payout period may be decreased by electing the accelerated benefit option The adjusted accelerated benefit is calculated using the selected annual benefit over the remaining period using a discounted rate, preferably 10%, wherein the selected annual benefit is discounted to present value (step 116). An eligible person choosing the accelerated benefit option may receive benefits for a predefined length of time, preferably, 18 months.

Additionally, if the employee dies during the payout period under either the standard or the lump sum option while covered by the plan, the covered person or entity, preferably, the employee's spouse or legal dependent, will continue to receive benefits under the plan. The surviving spouse may receive benefits until the end of the payout period, however, if the surviving spouse remarries, the new spouse will not be considered a covered person under the plan.

The selected maximum annual benefit is the total amount of benefits payable under the plan for an employee or an employee's spouse during any one calendar year (step 118). Benefits received under the plan by the employee must not exceed the amount of the selected maximum annual benefit. The benefits received cannot exceed the selected annual benefit in any one calendar year (step 120), unless the accelerated benefit option is elected. The payout period will decrease on a pro-rata basis of any benefits used and benefits will be paid to the covered person or persons for a predetermined length of time. Additionally, the benefits received during the payout period may be subject to state or federal tax.

If the eligible person does not have expenses equal to the selected annual benefit, the person may carry over the unused amount to proportionately extend the length of the payout period (step 122).

Having described in detail the preferred embodiment of the present invention, including its preferred modes of operation and functions, it is to be understood that this operation could be carried out with different elements and steps. This preferred embodiment is presented only by way of example and is not meant to limit the scope of the present invention, which is defined by the following claims.

What is claimed is:

1. A computer-implemented data-processing method for providing post-retirement qualified health care benefits funded using an accident and health insurance plan (hereinafter “senior lifestyles benefit plan”) that is paid for during a covered person's working years to a person covered under the plan, the method comprising the steps of:
a. providing a computer system for executing the computer-implemented data-processing method, the computer system having a data processing program to manipulate and process a plurality of variables input into the program;
b. electing a number of benefit payout years for receiving benefits during a payout period, wherein the benefit payout years are selected from the group of l under a standard non-lump-sum premium option, or r under a lump sum premium option;
c. electing a premium pay-in option wherein the pay-in option consists of the group selected from a standard non-lump-sum option and a lump sum option;
d. selecting and inputting into the data processing program standard non-lump-sum variables if the standard non-lump-sum premium option is elected by the employee, the standard non-lump-sum variables having a number of pay-in years, k for an associated number of payout years l, and an annual maximum benefit amount, B;
e. selecting and inputting into the data processing program lump sum variables if the lump sum premium option is elected by the employee, the lump sum variables having a number of elimination years q for an associated number of lump sum payout years r, and a lump sum annual maximum benefit amount LB;
f. using the data processing program to calculate a schedule of premiums to be paid based on at least one of the standard non-lump-sum variables and the lump sum variables to obtain an associated maximum benefit amount; and
g. paying a maximum benefit amount for qualified health expenses incurred by eligible plan members upon occurrence of a triggering event.

2. The method of claim 1 wherein the step of using the data processing program to calculate a schedule of premiums to be paid based on the standard non-lump-sum variables comprises the step of:
calculating bi-weekly premiums to be paid to an insurance company offering the senior lifestyles benefit plan during the pay-in period k based on a credited interest rate, i^{c}.

3. The method of claim 2, wherein the step of calculating bi-weekly premiums to be paid to the insurance company during the pay-in period k based on a credited interest rate comprises the steps of:
a. providing an assumptions spreadsheet having a standard non-lump-sum assumptions portion;
b. providing a layout spreadsheet by importing standard assumption variables from the standard portion of the assumptions spreadsheet into the layout spreadsheet using a plurality of embedded commands programmed within a plurality of cells within the layout sheet;
c. generating a standard credited interest rate table using a standard credited interest rate algorithm, wherein the credited interest rate algorithm being one of the plurality of embedded commands programmed within the plurality of cells within the layout sheet; and
d. generating a bi-weekly premium schedule of bi-weekly contributions based on the standard credited interest rate table generated in step 3c.

4. The method of claim 3 wherein the step of providing the assumption spreadsheet comprises the step of:
defining standard assumption variables into the standard non-lump-sum portion of the assumptions spreadsheet.

5. The method of claim 4 wherein the step of defining the standard assumption variables comprises the steps of:
defining a plurality of mortality rates;
defining an annual lapse rate of 10%;
defining an early retirement rate of 1% annually;
defining a net investment return rate i of 5.0%;
defining an initial fixed expense of $1.00 per $1,000 of annual maximum benefit;
defining an annual maximum benefit of $1,000.00
defining a commission of 4% annually;
defining administration fees including a pay-in period administration fee rate of 8%, and further including a payout administration fee rate of 7%;
defining a premium tax rate of 2.5%; and
defining a profit goal of 6%, the profit goal of 6% calculated using a present value of profits, PVᵢ(profit), discounted at the net investment return rate i, divided by a present value of premiums, PVᵢ(premium), discounted at the net investment return rate of i.

6. The method of claim 3 wherein the step of providing the layout spreadsheet comprises the step of:
providing a plurality of columns having a plurality of associated rows defined by the plurality of associated cells, wherein each associated row within the plurality of associated rows represents a policy year.

7. The method of claim 3 wherein the step of generating a standard credited interest rate table using a standard credited interest rate algorithm comprises the steps of:
a) importing standard non-lump-sum assumption variables into the layout sheet;
b) initially setting a pay-in year k equal to 1;
c) initially setting a payout year l equal to 1;
d) initially setting a lower bound i^{c}_{L} of an estimated standard credited interest rate Ei^{c} equal to a lower bound percentage, and setting i^{c}_{U} equal to a net investment return rate i imported from the assumptions sheet;
e) calculating the estimated credited interest rate Ei^{c} for an associated pay-in year k and an associated payout year l, wherein the step of calculating the estimated credited interest rate Ei^{c} for an associated pay-in year k and an associated payout year l provides the following substeps:
i) averaging i^{c}_{L} and i^{c}_{U}, by adding i^{c}_{L} and i^{c}_{U} and then dividing the sum by 2,
ii) setting Ei^{c} equal to the average of i^{c}_{L} and i^{c}_{U} of step 7e)i,
iii) obtaining an estimated bi-weekly premium amount using the Ei^{c} from step 7e)ii by calculating an estimated bi-weekly payroll deduction amount, eX, for a standard premium payment, wherein the estimated bi-weekly payroll deduction amount is calculated using a formula eX=ef(Ei^{c}), wherein
ef(Ei^{c})=B*[(1−(1+Ei^{c})^{-l})/(1−(1+Ei^{c})^{-k})]*[((1+Ei^{c})^{-1/13}−1)/Ei^{c}]*[(1+Ei^{c})^{(7/13)-k}],
iv) importing a present value of profit, PVi (profit) from the layout sheet, discounted at the net investment rate, i, wherein the present value of profit is a summation of present values of a plurality of profits, the plurality of profits calculated within the layout sheet based on the Ei^{c} from step 7e)ii, importing a present value of premium, PVi (premium) from the layout sheet, discounted at the net investment rate, i, wherein the present value of premium is a summation of present values of a plurality of premiums, the plurality of premiums calculated within the layout sheet based on the Ei^{c} from step 7e)ii, and using the PVi (profit) and PVi (premium) to calculate a profit margin, wherein the profit margin equals PVᵢ(profit)/PVᵢ(premium),
v) comparing the profit margin from step 7e)iv with a profit goal imported from the assumptions sheet,
vi) recalculating Ei^{c} by setting i^{c}_{L} equal to the Ei^{c} from step 7e)ii, and by keeping i^{c}_{U} unchanged if the profit margin is greater than the profit goal, thus raising the estimated credited interest rate to reduce the profit,
vii) recalculating Ei^{c} by keeping i^{c}_{L} unchanged, and by setting i^{c}_{U} equal to the Ei^{c} from step 7e)ii if the profit margin is less than the profit goal, thus lowering the estimated credited interest rate, and
viii) repeating steps 7e)i-vii until the profit margin equals the profit goal;
f) setting the standard credited interest rate i^{c} for the associated k and the associated l equal to the final Ei^{c} used in the last iteration of steps 7e)i-viii when the profit margin equals the profit goal;
g) outputting i^{c} from step 7f into a credited interest rate table sheet;
h) incrementing l by one;
i) repeating steps 7d-h until l exceeds the maximum payout year;
j) incrementing k by one; and
k) repeating steps 7c-j until k exceeds the maximum pay-in year.

8. The method of claim 3, wherein the step of generating bi-weekly premium payments for insertion into a bi-weekly premium portion of a premium schedule comprises provides the step of:
inserting a calculated credited interest rate from the credited interest rate table for an associated pay-in year k and an associated payout year l into a bi-weekly premium payment formula, wherein the bi-weekly premium payment formula uses a benefit amount B, a credited interest rate i^{c} for each associated pay-in year k and payout year l, and wherein the bi-weekly premium payment formula equals B*[(1−(1+i^{c})^{-l})/(1−(1+i^{c})^{-k})]*[((1+i^{c})^{-1/13}−1)/i^{c}]*[(1+i^{c})^{(7/13)-k}].

9. The method of claim 1 wherein the step of using the data processing program to calculate a schedule of lump sum premiums to be paid based on the lump variables comprises the step of:
calculating lump sum premiums to be paid to an insurance company offering the senior lifestyles benefit plan during the elimination period q based on a lump sum credited interest rate Li^{c}.

10. The method of claim 9 wherein the step of calculating lump sum premiums to be paid to an insurance company during a first year of the elimination period q based on a lump sum credited interest rate Li^{c} comprises the steps of:
a. providing an assumptions spreadsheet having a lump sum assumptions portion;
b. providing a lump sum layout spreadsheet by importing lump sum assumption variables from the lump sum portion of the assumptions spreadsheet into the lump sum using a plurality of lump sum embedded commands programmed within a plurality of lump sum cells within the lump sum layout sheet;
c. generating a lump sum credited interest rate table using a lump sum credited interest rate algorithm, wherein the algorithm being one of the plurality of lump sum embedded commands; and
d. generating a lump sum premium schedule of lump sum contributions based on the lump sum credited interest rate table generated in step 10c.

11. The method of claim 10 wherein the step of providing the assumption spreadsheet comprises the step of:
defining lump sum assumption variables into the lump sum portion of the assumptions spreadsheet.

12. The method of claim 11 wherein the step of defining the lump sum assumption variables comprises the steps of:
defining a plurality of mortality rates;
defining a lump sum early retirement rate of 1% annually;
defining a lump sum net investment return rate Li of 5.5%;
defining a lump sum initial fixed expense of $100;
defining a lump sum annual maximum benefit of $1,000;
defining a lump sum commission of 6%;
defining lump sum administration fees, the lump sum administration fees including an elimination period administration rate of 7% for the first year of the lump sum premium option, a lump sum deferred period administration rate of 0%, and a lump sum payout period administration fee of 9%;
defining a lump sum premium tax rate of 2.5%; and
defining a lump sum profit goal of 9%. the lump sum profit goal of 9% calculated using a present value of lump sum profits, LPV_{Li}(profit), discounted at the lump sum net investment return rate Li, divided by a present value of a lump sum premium, LPV_{Li} (premium), discounted at the net investment return rate of Li.

13. The method of claim 10 wherein the step of providing the lump sum payout spreadsheet further comprises the step of:
providing a plurality of lump sum columns having a plurality of associated lump sum rows defined by the plurality of associated lump sum cells, wherein each associated lump sum row within the plurality of associated lump sum rows represents a policy year.

14. The method of claim 10 wherein the step of generating a lump sum credited interest rate table using a lump sum credited interest rate algorithm comprises the steps of:
a) importing lump sum assumption variables into the lump sum layout sheet;
b) initially setting an elimination year q equal to 1;
c) initially setting a payout year r equal to 1;
d) initially setting a lump sum lower bound Li^{c}_{L} of an estimated standard credited interest rate ELi^{c} equal to a lump sum lower bound percentage, and setting Li^{c}_{U} equal to a lump sum net investment return rate Li imported from the assumptions sheet;
e) calculating the estimated lump sum credited interest rate ELi^{c} for an associated elimination year q and an associated lump sum payout year r, wherein the step of calculating the estimated lump sum credited interest rate ELi^{c} for an associated elimination year q and an associated payout year r provides the following substeps:
i) averaging Li^{c}_{L} and Li^{c}_{U}, by adding Li^{c}_{L} and L i^{c}_{U} and then dividing the sum by 2,
ii) setting ELi^{c} equal to the average of Li^{c}_{L} and Li^{c}_{U} of step 14e)i,
iii) obtaining an estimated lump sum premium amount using the ELi^{c} from step 14e)ii by calculating an estimated lump sum payroll deduction amount, eY, for a lump sum premium payment, wherein the estimated lump sum payroll deduction amount is calculated using a formula eY=ef(ELi^{c}), wherein
ef(ELi^{c})=LB*[(1−(1+ELi^{c})^{-r})/ELi^{c}]*(1+ELi^{c})^{1/2-q},
iv) importing a present value of lump sum profits, LPV_{Li} (profit) from the lump sum layout sheet, discounted at the lump sum net investment rate, Li, wherein the present value of lump sum profits is a summation of present values of a plurality of lump sum profits, the plurality of lump sum profits calculated within the lump sum layout sheet based on the ELi^{c} from step 14e)ii, and importing a present value of a lump sum premium, LPV_{Li} (premium) from the lump sum layout sheet, discounted at the lump sum net investment rate, Li, wherein the lump sum premium is calculated within the lump sum layout sheet based on the ELi^{c} from step 14e)ii, and using the LPV_{Li} (profit) and LPV_{Li} (premium) to calculate a lump sum profit margin, wherein the lump sum profit margin equals LPV_{Li}(profit)/LPV_{Li} (premium),
v) comparing the lump sum profit margin from step 14e)iv with a lump sum profit goal imported from the assumptions sheet,
vi) recalculating ELi^{c} by setting Li^{c}_{L} equal to the ELi^{c} from step 14e)ii, and by keeping Li^{c}_{U} unchanged if the lump sum profit margin is greater than the lump sum profit goal, thus raising the estimated lump sum credited interest rate to reduce the lump sum profit,
vii) recalculating Ei^{c} by keeping i^{c}_{L} unchanged, and by setting i^{c}_{U} equal to the Ei^{c} from step 14e)ii if the profit margin is less than the profit goal, thus lowering the estimated credited interest rate, and
viii) repeating steps 14e)i-vii until the lump sum profit margin equals the lump sum profit goal;
f) setting the lump sum credited interest rate Li^{c} for the associated q and the associated r equal to the final ELi^{c} used in the last iteration of steps 14e)i-viii when the profit margin equals the profit goal;
g) outputting Li^{c} from step 14f into a lump sum credited interest rate table sheet;
h) incrementing r by one;
i) repeating steps 14d-h until r exceeds the maximum payout year;
j) incrementing q by one; and
k) repeating steps 14c-j until q exceeds the maximum elimination year.

15. The method of claim 10 wherein the step of generating lump sum premium payments for insertion into a lump sum premium portion of a premium schedule comprises provides the step of:
inserting a calculated lump sum credited interest rate from the lump sum credited interest rate table for an associated elimination year q and an associated payout year r into a lump sum premium payment formula, wherein the lump sum premium payment formula uses a lump sum benefit amount LB, a lump sum credited interest rate Li^{c} for each associated elimination year q and payout year r, and wherein the lump sum premium payment formula equals LB*[(1−(1+Li^{c})^{-r})/Li^{c}]*(1+Li^{c})^{1/2-}.

16. The method of claim 1 wherein the triggering event is selected from the group consisting of a lapse in paying premiums, an employee's retirement, an employee's total disability, an employee's termination of employment, and an employee's death.

17. The method of claim 16 further comprising the step of:
returning up to 100% of the paid premiums to at least one of a covered person and entity if the triggering event of an employee's death occurs during at least one of the pay-in period and the elimination period.

18. The method of claim 16 further comprising the step of:
paying benefits up to a selected annual maximum for a predefined payout period if the triggering event occurs during the payout period.

19. The method of claim 18 further comprising the step of:
carrying over a balance of an unused amount of annual maximum benefits to proportionately extend a length of the predefined payout period.

20. The method of claim 19 further comprising the step of:
providing an accelerated pay-out benefit option allowing an employee planholder to reduce the elected payout period by discounting maximum benefits to a present value using a 10% discount rate when a covered person is eligible to receive benefits during the payout period for any reason;

21. The method of claim 20 further comprising the steps of:
providing lapse payment benefits when the triggering event of a lapse occurs during at least one of the pay-in years under the standard option and the elimination period under the lump sum option, wherein the lapse payment is an actual premium paid in divided by an expected premium multiplied by a surcharge rate.

22. The method of claim 21 wherein the surcharge rate is 80%.

23. A computer-implemented data-processing method for providing post-retirement qualified health care benefits funded using an accident and health insurance plan (hereinafter “lifestyles senior benefit plan”) that is paid for during a covered person's working years to a person covered under the plan, the method comprising the steps of:
a. providing a computer system for executing the computer-implemented data-processing method, the computer system having a data processing program to manipulate and process a plurality of variables input into the program;
b. electing a number of benefit payout years for receiving benefits during a payout period, wherein the benefit payout years are selected from the group of l under a standard non-lump-sum premium option, or r under a lump sum premium option;
c. electing a premium pay-in option wherein the pay-in option consists of the group selected from a standard non-lump-sum option and a lump sum option;
d. selecting and inputting into the data processing program standard non-lump-sum variables if the standard non-lump-sum premium option is elected by the employee, the standard non-lump-sum variables having a number of pay-in years, k for an associated number of payout years l, and an annual maximum benefit amount, B;
e. selecting and inputting into the data processing program lump sum variables if the lump sum premium option is elected by the employee, the lump sum variables having a number of elimination years q for an associated number of lump sum payout years r, and a lump sum annual maximum benefit amount LB;
f. using the data processing program to calculate a schedule of premiums to be paid based on at least one of the standard non-lump-sum variables and the lump sum variables to obtain an associated maximum benefit amount; and
g. paying a maximum benefit amount for qualified health expenses incurred by eligible plan members upon occurrence of a triggering event, wherein the triggering event is selected from the group consisting of a lapse in paying premiums, an employee's retirement, an employee's total disability, an employee's termination of employment, and an employee's death.

24. The method of claim 23 further comprising the step of:
returning up to 100% of the paid premiums to at least one of a covered person and entity if the triggering event of an employee's death occurs during at least one of the pay-in period and the elimination period.

25. The method of claim 24 further comprising the step of:
paying benefits up to a selected annual maximum for a predefined payout period if the triggering event occurs during the payout period.

26. The method of claim 25 further comprising the step of:
carrying over a balance of an unused amount of annual maximum benefits to proportionately extend a length of the predefined payout period.

27. The method of claim 26 further comprising the step of:
providing an accelerated pay-out benefit option allowing an employee planholder to reduce the elected payout period by discounting maximum benefits to a present value using a 10% discount rate when a covered person is eligible to receive benefits during the payout period for any reason.

28. The method of claim 23 further comprising the steps of:
providing lapse payment benefits when the triggering event of a lapse occurs during at least one of the pay-in years under the standard option and the elimination period under the lump sum option, wherein the lapse payment is an actual premium paid in divided by an expected premium multiplied by a surcharge rate.

29. A computer-implemented data-processing method for providing post-retirement qualified health care benefits funded using an accident and health insurance plan (hereinafter “lifestyles senior benefit plan”) that is paid for during a covered person's working years to a person covered under the plan, the method comprising the steps of:
a. providing a computer system for executing the computer-implemented data-processing method, the computer system having a data processing program to manipulate and process a plurality of variables input into the program;
b. electing a number of benefit payout years for receiving benefits during a payout period, wherein the benefit payout years are selected from the group of l under a standard non-lump-sum premium option, or r under a lump sum premium option;
c. electing a premium pay-in option wherein the pay-in option consists of the group selected from a standard non-lump-sum option and a lump sum option;
d. selecting and inputting into the data processing program standard non-lump-sum variables if the standard non-lump-sum premium option is elected by the employee, the standard non-lump-sum variables having a number of pay-in years, k for an associated number of payout years l, and an annual maximum benefit amount, B;
e. selecting and inputting into the data processing program lump sum variables if the lump sum premium option is elected by the employee, the lump sum variables having a number of elimination years q for an associated number of lump sum payout years r, and a lump sum annual maximum benefit amount LB;
f. using the data processing program to calculate a schedule of premiums to be paid based on at least one of the standard non-lump-sum variables and the lump sum variables to obtain an associated maximum benefit amount;
g. paying a maximum benefit amount for qualified health expenses incurred by eligible plan members upon occurrence of a triggering event, wherein the triggering event is selected from the group consisting of a lapse in paying premiums, an employee's retirement, an employee's total disability, an employee's termination of employment, and an employee's death;
h. returning up to 100% of the paid premiums to at least one of a covered person and entity if the triggering event of an employee's death occurs during at least one of the pay-in period and the elimination period;
i. paying benefits up to a selected annual maximum for a predefined payout period if the triggering event occurs during the payout period;
j. carrying over a balance of an unused amount of annual maximum benefits to proportionately extend a length of the predefined payout period;
k. providing an accelerated pay-out benefit option allowing an employee planholder to reduce the elected payout period by discounting maximum benefits to a present value using a discount rate when a covered person is eligible to receive benefits during the payout period for any reason; and
l. providing lapse payment benefits when the triggering event of a lapse occurs during at least one of the pay-in years under the standard option and the elimination period under the lump sum option, wherein the lapse payment is an actual premium paid in divided by an expected premium multiplied by a surcharge rate.
